(19) United States
(12) Patent Application Publication
(10) Pub. No.: US 2019/0343190 A1
(43) Pub. Date: Nov. 14, 2019

(54) MATERIALS INCLUDING POLYMERIC FIBERS INCORPORATING MICROCAPSULES OR NANOCAPSULES INCLUDING AN ESSENTIAL OIL

(71) Applicant: President and Fellows of Harvard College, Cambridge, MA (US)

(72) Inventors: Elizabeth Olayinka Ogunbiyi, Cambridge, MA (US); Kevin Kit Parker, Cambridge, MA (US)

(21) Appl. No.: 16/337,454

(22) PCT Filed: Sep. 28, 2017
(86) PCT No.: PCT/US17/54125

§ 371 Date: Mar. 28, 2019

Related U.S. Application Data
(60) Provisional application No. 62/401,992, filed on Sep. 30, 2016.

(51) Int. Cl. A41B 11/00; A01N 65/44; A01N 25/28; A01N 25/34; B32B 1/08; B32B 5/02; D02G 3/04

(52) U.S. Cl. CPC A41B 11/005; A01N 65/44; A01N 25/28; A01N 25/34; B32B 1/08; B32B 5/024; D10B 2501/02; A41B 2500/20; A41B 2400/34; B32B 2262/023; B32B 2262/0261; B32B 2307/7145; B32B 2437/00; D02G 3/045

(57) ABSTRACT

The present disclosure provides materials and articles of clothing including a plurality of nanocapsules, each nanocapsule including a polymeric shell surrounding at least one fluid, and a plurality of polymeric fibers co-spun with the plurality of nanocapsules. The nanocapsules can be made by miniemulsion polymerization. The encapsulated at least one fluid can include at least one essential oil. In some embodiments, the materials are deodorizing, antifungal, and/or antibacterial. Methods of manufacturing the materials and articles of clothing are also provided.

### RELATED APPLICATIONS

This application claims the benefit of priority to U.S. Provisional Application No. 62/401,992, filed on Sep. 30, 2016, the entire contents of which are incorporated herein by reference.

### BACKGROUND OF THE INVENTION

Bromhidrosis pedum or foot odor affects 32% of Americans. While its effects are not life threatening, the smell can persist on feet, socks, and shoes and ranges in intensity from a light vinegary sweat smell to a decidedly noxious aroma of rancid fat. These symptoms easily generate social embarrassment and sensory discomfort. Exercise, irregular washing and a genetic disposition to certain foot flora amplify foot odor. More generally, the simple act of wearing shoes provides the ideal conditions of warmth, poor ventilation, and moisture for bacterial growth and odor generation.

Foot odor is caused by the enzymatic breakdown of sweat and skin compounds by bacteria. For example, Brevibacterium linens breaks down methionine to produce methanethiol, which exudes a cheesy smell. Propionibacteria breaks down glycerol to produce propanoic acid, which exudes a vinegary smell. Staphylococcus epidermis and Bacillus subtilis break down leucine and other branched chain amino acids to produce iso/valeric and iso/butyric acid, which exude scents of sweat, cheese, rancid butter, and vomit.

While there are steps a sufferer of foot odor can take to mitigate or eliminate odor, many of these steps do not address the underlying microbial cause of odor. Further, such steps may require repetition and typically are temporary in nature. Antibacterial products such as deodorants (triclosan or essential oils) and silver or copper nanofiber socks raise antibacterial resistance and offer poor wash durability. Botox injections prevent sweating but are expensive and temporary. Sweat may be removed with moisture wicking socks, but such socks are often ineffective for odor reduction and may be too thick. Odor control products such as activated carbon shoe deodorizers may address produced odor but do not locally remove the source of odor on the feet.

Accordingly, there is a need for improved methods and materials that target the underlying material microbial cause of odor that are convenient, and that last for a sufficiently long period of time.

### SUMMARY

In accordance with some embodiments of the present disclosure, a material includes a plurality of nanocapsules, each nanocapsule comprising a polymeric shell surrounding at least one fluid, and a plurality of polymeric fibers co-spun with the plurality of nanocapsules.

In some embodiments, the at least one fluid surrounded by the polymeric shell is capable of being encapsulated by miniemulsion polymerization. In some embodiments, the nanocapsules were produced by miniemulsion polymerization.

In some embodiments, each of the nanocapsules is at least partially embedded in one or more of polymeric fibers.

In some embodiments, the at least one fluid comprises an essential oil. In some embodiments, the essential oil comprises lemongrass.

In some embodiments, each polymeric shell comprises polystyrene.

In some embodiments, the polymeric shell is configured to enable the at least one fluid to diffuse through the polymeric shell. In some embodiments where the at least one fluid is an essential oil, the polymeric shell is configured to enable the at least one essential oil to diffuse through the polymeric shell.

In some embodiments, each of the nanocapsules has a diameter in a range of 10 nm to 1.1 μm. In some embodiments, each of the nanocapsules has a diameter in a range of 10 nm to 900 nm. In some embodiments, each of the nanocapsules has a diameter in a range of 10 nm to 300 nm.

In some embodiments, each of the polymeric fibers has a diameter in a range of 10 nm to 3 μm. In some embodiments, each of the polymeric fibers has a diameter in a range of 10 nm to 900 nm.

In some embodiments, the material is a non-woven polymeric fiber sheet.

In some embodiments, the material is woven.

In some embodiments, the material includes a yarn that includes the plurality of polymeric fibers and the plurality of nanocapsules.

In some embodiments, the material is a polymeric fiber sheet including the plurality of polymeric fibers and the plurality of nanocapsules.

In some embodiments, the material also includes at least a first layer of fabric adjacent to a first face of the polymeric fiber sheet, and at least a second layer of fabric adjacent to a second face of the polymeric fiber sheet opposite the first face. In some embodiments, at least one of the first layer of fabric and the second layer of fabric comprises wool.

In some embodiments, the material inhibits the growth and/or activity of a microbe.

In some embodiments, the material is two or more of deodorizing, antifungal, and antibacterial. In some embodiments, the material is deodorizing, antifungal, and antibacterial

In accordance with some embodiments of the present disclosure, a method of manufacturing a material includes providing a fiber-forming liquid including a polymer and a plurality of nanocapsules, each nanocapsule including a fluid encapsulated by a polymeric shell formed using miniemulsion polymerization. The method also includes forming a plurality of polymeric fibers co-spun with the plurality of nanocapsules by ejecting or flinging the fiber-forming liquid from a reservoir.

In some embodiments, the method also includes encapsulating the fluid in a plurality of polymeric shells by means of miniemulsion polymerization thereby forming the plurality of nanocapsules. In some embodiments, encapsulation includes the use of divinylbenzene as a polymerization agent.

In some embodiments, the method is a method of manufacturing a material that inhibits the growth and/or activity of a microbe. In some embodiments, the resulting material inhibits the growth and/or activity of a microbe.

In some embodiments, each of the nanocapsules in the fiber-forming liquid has a diameter in a range of 10 nm to 1.1 μm. In some embodiments, each of the nanocapsules in the fiber-forming liquid has a diameter in a range of 10 nm to 900 nm. In some embodiments, each of the nanocapsules in the fiber-forming liquid has a diameter in a range of 10 nm to 300 nm.

In some embodiments, the fiber-forming liquid is ejected or flung from the reservoir such that the resulting polymeric fibers each have a diameter in a range of 10 nm to 1.1 μm. In some embodiments, the fiber-forming liquid is ejected or flung from the reservoir such that the resulting polymeric fibers each have a diameter in a range of 10 nm to 900 nm.

In some embodiments, the weight percent ratio of nanocapsules to polymer in the fiber-forming liquid falls in the range of 1:1 to 1:4.

In some embodiments, the method also includes collecting the formed plurality of polymeric fibers on a collection surface. In some embodiments, the collection surface has a shape corresponding to an article of clothing and the resulting fiber material has a shape corresponding to an article of clothing.

In some embodiments, the method also includes twisting the plurality of fibers into a yarn.

In accordance with some embodiments of the present disclosure, a method of making an article of clothing that inhibits growth and/or activity of a microbe is disclosed. The method includes manufacturing a material. The method further includes disposing a first layer of fabric adjacent to a first surface of the material and disposing a second layer of fabric adjacent to a second surface of the material thereby forming a layered material. The method further includes making an article of clothing using the layered material.

In some embodiments, at least one of the first layer of fabric and the second layer of fabric comprise wool.

In accordance with some embodiments of the present disclosure, an article of clothing is disclosed. The article of clothing includes a sheet. The sheet includes plurality of nanocapsules, each nanocapsule comprising a polymeric shell surrounding at least one fluid, and a plurality of polymeric fibers co-spun with the plurality of nanocapsules. In some embodiments, the at least one fluid includes at least one essential oil. In some embodiments, the at least one fluid was encapsulated using miniemulsion polymerization.

In some embodiments, the article of clothing is a sock.

In some embodiments, the article of clothing further includes at least a first layer of fabric adjacent to a first face of the sheet and at least a second layer of fabric adjacent to a second face of the sheet. In some embodiments, at least one of the first layer of fabric and the second layer of fabric comprise wool.

In some embodiments, the article of clothing is configured to maintain at least about 10% by weight essential oil relative to nanofiber content after about 50 washes.

In some embodiments, the article of clothing inhibits the growth and/or activity of a microbe.

Additional features and advantages are realized through the techniques of the present disclosure. Other embodiments and aspects of the disclosure are described in detail herein and are considered part of the invention. The recitation herein of desirable objects, which are met by various embodiments of the present disclosure, is not meant to imply or suggest that any or all of these objects are present as essential features, either individually or collectively, in the most general embodiment of the present disclosure, or in any of its more specific embodiments.

### BRIEF DESCRIPTION OF THE DRAWINGS

The features and advantages of the present disclosure will be more fully understood from the following description of exemplary embodiments when read together with the accompanying drawings. The drawings are intended to illustrate the teachings taught herein and are not intended to show relative sizes and dimensions, or to limit the scope of examples or embodiments. In the drawings, the same numbers are used throughout the drawings to reference like features and components of like function.

FIG. 1 schematically depicts a top view of polymeric fibers of a sheet according to an embodiment.

FIG. 2 schematically depicts an article of clothing, a polymeric fiber within the article of clothing, and a microcapsule or nanocapsule in the polymeric fiber according to an embodiment.

FIG. 3A is a cross-section view of a multilayered material according to some embodiments.

FIG. 3B is an exploded view of an article of clothing made from the mutilayered material according to some embodiments.

FIG. 4A schematically depicts the ejection of a fiber from a reservoir according to some embodiments.

FIG. 4B schematically depicts a system for fabricating polymeric fibers according to some embodiments.

FIG. 5 is an image of a sheet of fibers spun around a collection surface according to some embodiments.

FIG. 6 schematically depicts a process for making microcapsules or nanocapsules by miniemulsion polymerization according to some embodiments.

FIG. 7A is an image of polystyrene (PS) nanospheres produced by miniemulsion polymerization.

FIG. 7B is an image of lemongrass-PS nanocapsules produced by the miniemulsion polymerization process depicted in FIG. 6.

FIG. 8A is a graph depicting the volume distribution of PS nanobeads produced by miniemulsion polymerization.

FIG. 8B is a graph depicting the volume distribution of lemongrass-PS microcapsules and nanocapsules made by miniemulsion polymerization with a 1:1 ratio of polystyrene (PS) to lemongrass.

FIG. 8C is a graph depicting the volume distribution of lemongrass-PS/divinylbenzene (DVB) microcapsules and nanocapsules made by miniemulsion polymerization from a solution with 10% wt divinylbenzene relative to the initial weight of styrene.

FIG. 8D is a graph depicting the volume distribution of lemongrass-PS/DVP microcapsules and nanocapsules made by miniemulsion polymerization from a solution with 20% wt divinylbenzene relative to the initial weight of styrene.

FIG. 8E is a graph depicting the volume distribution of lemongrass-PS/DVP microcapsules and nanocapsules made by miniemulsion polymerization from a solution with 30% wt divinylbenzene relative to the initial weight of styrene.

FIG. 9A is a scanning electron microscope (SEM) image of nanofibers produced by spinning of a solution polycaprolactone (PCL) in hexafluoroisopropanol (HFIP) without nanobeads used as a control.

FIG. 9B is an SEM image of PCL nanofibers incorporating 0.8 μm diameter polystyrene nanobeads spun from a solution of 6 v/v % PCL in HFIP.

FIG. 9C is a SEM image of PCL nanofibers incorporating 1.75 μm diameter fluorescent nanobeads spun from a solution including 6 v/v % PCL in HFIP).

FIG. 9D is a detail view of a portion of the image in FIG. 9A.

FIG. 9E is a detail view of a portion of the image in FIG. 9B.

FIG. 9F is a detail view of a portion of the image in FIG. 9C.

FIG. 10 is a graph of fiber diameters of the PCL nanofibers depicted in FIG. 9A-9F.

FIG. 11A is an SEM image of PCL nanofibers incorporating polystyrene nanobeads.

FIG. 11B is a Canny edge filtered version of the image in FIG. 11A.

FIG. 12A is an SEM image of control nanofibers produced without nanobeads showing irregular beading.

FIG. 12B is another SEM image of control nanofibers produced without nanobeads showing irregular beading.

FIG. 12C is an SEM image of nanofibers incorporating 0.8 μm PS nanobeads.

FIG. 13 is a SEM image of a nanofiber including 0.8 μm diameter nanobeads illustrating measurements of sphere diameter and sphere separation distance.

FIG. 14 is a graph depicting the relationship between the measured diameter of spheres in the nanofibers and the separation distance between the spheres for the nanofibers incorporating 0.8 μm diameter nanobeads.

FIG. 15A is a SEM image of a polymeric fiber spun from a solution of 6 v/v % nylon in HFIP without microparticles or nanoparticles.

FIG. 15B is a SEM image of a polymeric fiber spun from a solution of 8 v/v % nylon in HFIP without microparticles or nanoparticles.

FIG. 15C is a SEM image of a polymeric fiber spun from a solution of 10 v/v % nylon in HFIP without microparticles or nanoparticles.

FIG. 15D is a SEM image of a polymeric fiber spun from a solution of 12 v/v % nylon in HFIP without microparticles or nanoparticles.

FIG. 16 is a graph depicting the relationship between concentration of weight % of nylon in HFIP for the solution to produce the fibers and resulting fiber diameter obtained from SEM image analysis.

FIG. 17A is an SEM image of nylon fibers spun from a solution with a 1:1 wt % ratio of nanocapsules to nylon.

FIG. 17B is an SEM image of nylon fibers spun from a solution with a 1:2 wt % ratio of nanocapsules to nylon.

FIG. 17C is an SEM image of nylon fibers spun from a solution with a 1:4 wt % ratio of nanocapsules to nylon.

FIG. 17D is a SEM image of nylon fibers spun from a solution with a 1:10 wt % ratio of nanocapsules to nylon.

FIG. 18A is an image of a nanofiber material made from a solution with a 1:1 wt % ratio of lemongrass nanocapsules to nylon. Although not shown in this greyscale image, the original color image shows the material having a lemon yellow color.

FIG. 18B is an image of a nanofiber material made from a solution with a 1:2 wt % ratio of lemongrass nanocapsules to nylon. Although not shown in this greyscale image, the original color image shows the material having an off white/pale yellow color.

FIG. 18C is an image of a nanofiber material made from a solution with a 1:4 wt % ratio of lemongrass nanocapsules to nylon. Although not shown in this greyscale image, the original color image shows the material having an ivory color.

FIG. 18D is an image of a nanofiber material made from a solution with a 1:10 wt % ratio of lemongrass nanocapsules to nylon.

FIG. 19 is a graph depicting nanocapsule oil content in a nanofiber material as a function of wt % nanocapsules relative to nylon in the nylon-nanocapsule solution used to form the nanofiber material.

FIG. 20A is an image of three samples of nanofiber fabric pre-washing; specifically, a nanofiber material soaked in lemongrass oil (left), a nanofiber material sonicated with lemongrass oil nanocapsules (center), and a nanofiber material made of nanofibers that each incorporate lemongrass oil nanocapsules (right).

FIG. 20B is an image of the three samples of nanofiber fabric shown in FIG. 20A post-washing.

FIG. 21 is a graph depicting the relative amount of lemongrass retained after repeated washing for the three different fabric samples shown in FIG. 20A.

FIG. 22A is an image of a bacterial culture of Bacillus subtilis in nylon nanofibers.

FIG. 22B is an image of a bacterial culture of Bacillus subtilis in nylon nanofibers with a 10% initial concentration of lemongrass oil relative to the total weight of the material.

FIG. 22C is an image of a bacterial culture of Bacillus subtilis in nylon nanofibers with a 25% initial concentration of lemongrass oil relative to the total weight of the material.

FIG. 22D is an image of a bacterial culture of Staphylococcus epidermis in nylon nanofibers.

FIG. 22E is an image of a bacterial culture of Staphylococcus epidermis in nylon nanofibers with a 10% initial concentration of lemongrass oil relative to the total weight of the material.

FIG. 22F is an image of a bacterial culture of Staphylococcus epidermis in nylon nanofibers with a 25% initial concentration of lemongrass oil relative to the total weight of the material.

FIG. 23 is a graph depicting relative percentage of essential oil in a material as a function of time including experimental data and a prediction based on a zero order release kinetics model.

FIG. 24 is a graph depicting relative percentage of essential oil in a material in low saline solution and in high saline solution as a function of time and corresponding predictions based on a zero order release kinetics model.

### DETAILED DESCRIPTION

Described herein are materials, articles of clothing, methods of manufacturing a material, and methods of manufacturing an article of clothing. Some embodiments include a sheet including polymeric fibers that incorporate one or more microcapsules or nanocapsules including one or more fluids (e.g., an essential oil) that has antimicrobial properties. In some embodiments, the materials and articles of clothing inhibit the growth and/or activity of a microbe. In some embodiments, the materials and articles of clothing are deodorizing, antifungal, and/or antibacterial. In some embodiments, the materials and articles of clothing offer an effective solution for prevention or treatment of malodor associated with a portion of the body (e.g., foot malodor). In some embodiments, the materials and articles of clothing described herein remain effective for prevention or treatment of malodor associated with a portion of the body after multiple washings. In some embodiments, the materials and articles of clothing described herein are simple to manufacture. The materials and articles of clothing described herein may be incorporated in materials for use in high intensity physical activities, medical dressings, fashion fabrics, automobile upholstery, and other applicable applications.

### Materials and Articles of Clothing

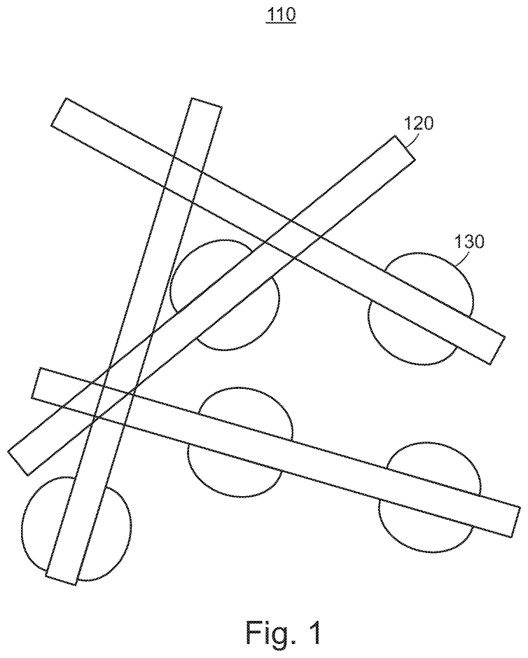

In some embodiments, a material includes at least one fiber sheet. FIG. 1 schematically depicts a top view of a portion of a fiber sheet 110 (e.g., a non-woven polymeric fiber sheet) according to some embodiments. In other embodiments, the material is a woven material and the sheet is a woven sheet. The at least one non-woven polymeric fiber sheet 110 includes a plurality of polymeric fibers 120 and a plurality of microcapsules or nanocapsules 130 disposed in or on the plurality of polymeric fibers 120. The microcapsules or nanocapsules 130 each include a polymeric shell surrounding at least one fluid. In some embodiments, the at least one fluid includes at least one essential oil. In some embodiments, the plurality of polymeric fibers are produced by co-spinning a liquid including a polymer and the plurality of microcapsules and nanocapsules. In some embodiments, each of the microcapsules or nanocapsules 130 is at least partially embedded at least one of the polymeric fibers 120 as a result of the co-spinning process used to produce the polymeric fibers.

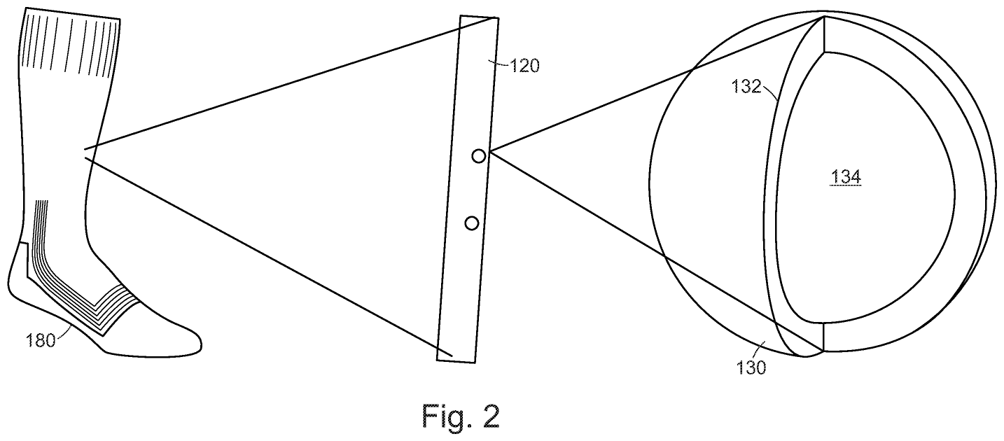

FIG. 2 schematically depicts an article of clothing 180 formed, at least in part, from a material that includes the non-woven polymeric fiber sheet 110, a polymeric fiber 120 of the non-woven polymeric fiber sheet 110, and a microcapsule or nanocapsule 130 in the polymeric fiber 120 according to some embodiments.

As noted above, the microcapsules or nanocapsules include at least one fluid 134. In some embodiment, the at least one fluid includes at least one essential oil. In some embodiments, the essential oil includes lemongrass oil, cinnamon oil, eucalyptus oil, vetiver oil, sandalwood oil, oregano oil, or combinations of the aforementioned.

The at least one essential oil includes lemongrass oil in some embodiments. Lemongrass oil is advantageous because it is non-toxic, affordable, and exhibits high antimicrobial activity. Other advantageous characteristics of lemongrass are that it is hydrophobic and exhibits antifungal activity. Furthermore, lemongrass oil contains a high percentage of citral. Citral is advantageous because the bacterial enzyme leucine dehydrogenase has a higher binding affinity with citral than branched chain amino acids. Higher binding affinity with leucine hydrogenase is beneficial because leucine hydrogenase breaks down leucine, iso-leucine, and valine (branched chain amino acids) into odorous compounds, including short chain fatty acids such as propanoic acid, butanoic acid and ethanoic acid. Citral prevents the amino acids from binding and being broken down, creating malodor, by binding with leucine hydrogenase. The table below lists some relevant characteristics of lemongrass oil including minimum inhibitory concentration (MIC) as well as those of some other essential oils.

| | | Fun- | Lethal | | | | | |
|---|---|---|---|---|---|---|---|---|
| | MIC | gal | Dose | Irri- | Cost | Odor | | Citral |
| | (v/v) % | MIC | g/kg | tant | $/g | Threshold | | % |
| Lemon- | .06 | .06 | 2 | No | .1 | 10 | ppb | 78.8 |
| grass | | | | | | | | |
| Cinnamon | .015 | .03 | 2.65 | Yes | 1.2 | 750 | ppb | 0 |
| Eucalyp- | .06-2.0 | .06-.4 | .05 | Yes | .2 | 12 | ppb | 3-70 |
| tus | | | | | | | | |
| Vetiver | .06 | .12 | >5 | No | .57 | 10 | ppb | 0 |
| Sandal- | .12 | .06 | 5.8 | Mild | 5.81 | .7 | ppb | 0 |
| wood | | | | | | | | |
| Oregano | .12 | .12 | 2.2 | No | .21 | 12 | ppb | 0 |

In some embodiments, each microcapsule or nanocapsule 130 includes a polymeric shell 132 surrounding the at least one fluid 134. In some embodiments, the polymeric shell 132 is configured to enable the at least one fluid 134 to diffuse through the polymeric shell 132. In embodiments where the at least one fluid includes at least one essential oil, the polymeric shell 132 is configured to enable the at least one essential oil to diffuse through the polymeric shell 132. The polymeric shell 132 includes polystyrene in some embodiments. Polystyrene is advantageous because it is inert, thermally stable, and insoluble in hexaflouroisopropanol (HFIP), which is a solvent that may be used in fabrication of the polymeric fibers 120.

In some embodiments, each of the microcapsules or nanocapsules has a diameter in a range of about 10 nm to about 1.1 μm, or in a range of about 10 nm to about 900 nm. In some embodiments, the polymeric fibers include nanocapsules and each of the nanocapsules independently has a diameter in a range of about 10 nm to about 900 nm. In some embodiments, the polymeric fibers include nanocapsules and each of the nanocapsules independently has a diameter in the range of about 10 nm to about 500 nm or in the range of about 130 nm to about 500 nm. In some embodiments, the polymeric fibers include nanocapsules and each of the nanocapsules independently has a diameter in the range of about 10 nm to about 300 nm. Further discussion regarding dimensions of nanocapsules is provided below in Example 1: Designing and Determining Capsule Diameter.

In some embodiments, each of the polymeric fibers independently has a diameter in a range of about 10 nm to about 3 μm. In some embodiments, each of the polymeric fibers independently has a diameter in a range of about 10 nm to about 500 nm. In some embodiments, each of the polymeric fibers independently has a diameter in a range of about 120 nm to are about 700 nm. Further discussion of diameters of polymeric fibers is provided in Example 2: Design, Preparation and Characterization of Nanofibers.

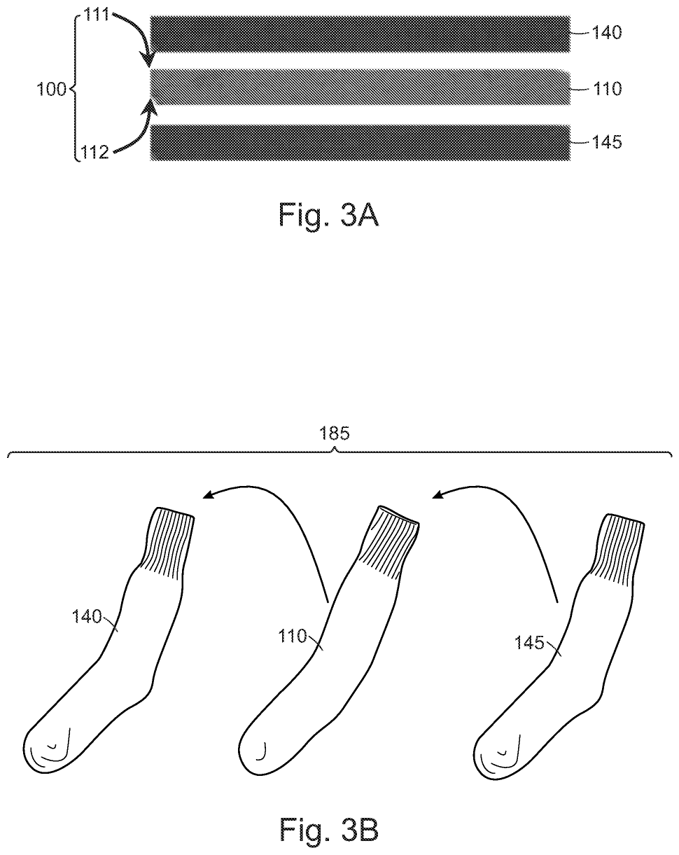

Some embodiments include a multilayered material that includes a sheet formed of polymeric fibers incorporating a plurality of microcapsules or nanocapsules including at least one fluid (e.g., including at least one an essential oil). FIG. 3A is an exploded view of a multilayered material 100 according to some embodiments. In some embodiments, the material 100 includes at least a first layer of fabric 140 adjacent to a first face 111 of the at least one fiber sheet 110 and at least a second layer of fabric 145 adjacent to a second face 112 of the at least one sheet 110. In some embodiments the at least one sheet is a non-woven sheet. In other embodiments, the at least one sheet is a woven sheet. In some embodiments, one or both of the first layer of fabric 140 and the second layer of fabric 145 include wool. In some embodiments, the material 100 may inhibit the growth and/or activity of a microbe. In some embodiments, the material 100 may be two or more of deodorizing, antifungal, and antibacterial. In some embodiments, the material 100 is deodorizing, antifungal, and antibacterial.

FIG. 3B is an exploded view of an article of clothing (e.g., a sock 185) including a multilayer material, such as multilayered material 100. In some embodiments, the multilayer material 100 may be used to form at least a portion of an article of clothing. In some embodiments, the article of clothing may be formed of multiple layers of materials with one of those layers being a sheet including polymeric fibers incorporating nanocapsules or microcapsules including at least one fluid (e.g., an essential oil).

### Methods for Generating Materials

Some embodiments include a method of manufacturing a material. The method includes providing a fiber-forming liquid including a polymer and nanocapsules each including at least one fluid (e.g., at least one essential oil). The method also includes forming a plurality of polymeric fibers having a plurality of microcapsules or nanocapsules disposed therein by ejecting or flinging the fiber-forming liquid from a reservoir, and collecting the plurality of polymeric fibers on a collection surface. In the description herein, the terms “liquid” (e.g., fiber-forming liquid) and “solution” (e.g., polymer solution) are used to refer to what is ejected or flung from a reservoir for formation of the polymeric fibers; however, one of ordinary skill in the art in view of this disclosure will appreciate that the “liquid” or “solution” that is ejected or flung from the reservoir includes a non-liquid component in the form of the polymeric shells of the microcapsules or the nanocapsules.

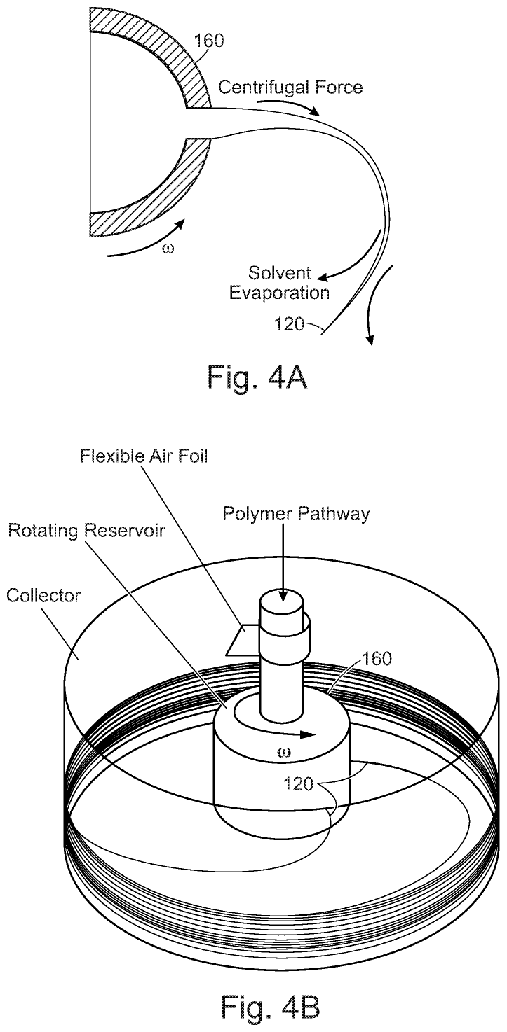

FIG. 4A schematically depicts formation of a polymeric fiber 120 by ejection of a steam of fiber-forming liquid including a polymer and microcapsules or nanocapsules from an orifice of a rotating reservoir 160 and subsequent evaporation of solvent from the ejected stream of fiber-forming liquid. FIG. 4B schematically depicts a system for formation of polymeric fibers 120. As shown, the system includes a rotating reservoir 160 and a collector in the form of a cylindrical wall for collecting the formed polymeric fibers 120. In some embodiments, a collector may have a different shape and may be disposed between the rotating reservoir and the cylindrical wall. In some embodiments, the collector is rotated and/or translated relative to the reservoir during collection of the polymeric fibers. Further details regarding systems for forming fibers, diameters of fibers, and materials for fibers are provided below.

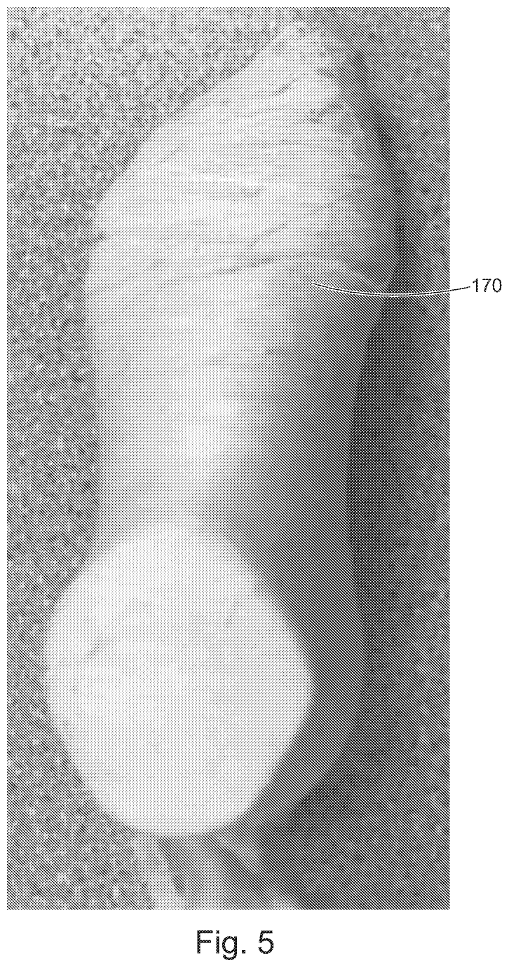

In some embodiments, methods including configuring the polymeric fibers in a desired shape. In some embodiments, this is accomplished by collecting the polymeric fibers onto a collection surface having the desired shape. FIG. 5 is an image of a sheet 110 of fibers 120 spun around a collection surface 170 according to some embodiments. In some embodiments, the collection surface 170 has a shape corresponding to an article of clothing 180 and the resulting material 100 has a shape corresponding to an article of clothing 180 as shown. In some embodiments, the collection surface 170 and material 100 have a shape corresponding to a sock. One of ordinary skill in the art will appreciate that the collection surface may have a shape corresponding to any article of clothing, any portion of a body of a person to be covered or any other suitable shape.

Suitable devices and use of the devices for fabricating the micron, submicron or nanometer dimension polymeric fibers for use in the methods of the present invention are described in U.S. Pat. No. 9,410,267, U.S. Patent Publication No. 2013/0312638, U.S. Pat. No. 9,738,046, and U.S. Patent Publication No. 2015/0354094, the contents of each of which are incorporated in their entirety by reference.

The micron, submicron or nanometer dimension polymeric fibers may each independently have a diameter of about 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 33, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000 nanometers, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 10, 20, 30, 40, or about 50 micrometers (μm). In some embodiments, the polymeric fibers each independently have a diameter of about 0.5-3 μm. In some embodiments, the polymeric fibers each independently have a diameter of about 0.7 to 1.3 μm. In some embodiments, an average diameter of each of the formed polymeric fibers is independently between about 0.75 μm and about 1.25 μm. In some embodiments the average diameter of each of the formed polymeric fibers is independently about 1 μm. Ranges and values intermediate to the above recited ranges and values are also contemplated to be part of the invention.

Exemplary materials used to make fibers include synthetic polymers, such as polyethylene, polypropylene, poly(lactic acid), etc.

In some exemplary embodiments, the synthetic polymers may be specifically synthesized to possess domains along the backbone that may be activated for specific purposes including, but not limited to, specific binding, folding, unfolding, etc.

Exemplary polymers for use in the methods of the invention may be biocompatible or nonbiocompatible, synthetic or natural, such as, for example, synthetic or natural polymers having shear induced unfolding, or combinations thereof. Exemplary polymers include, for example, poly(urethanes), poly(siloxanes) or silicones, poly(ethylene), poly(vinyl pyrrolidone), poly(2-hydroxy ethyl methacrylate), poly(N-vinyl pyrrolidone), poly(methyl methacrylate), poly(vinyl alcohol), poly(acrylic acid), polyacrylamide, poly(ethylene-co-vinyl acetate), poly(ethylene glycol), poly(methacrylic acid), polylactides (PLA), polyglycolides (PGA), poly(lactide-co-glycolides) (PLGA), polyanhydrides, polyphosphazenes, polygermanes, polyorthoesters, polyesters, polyamides, polyolefins, polycarbonates, polyaramides, polyimides, polycaprolactone (PCL), and copolymers and derivatives thereof, and combinations thereof.

Exemplary biogenic polymers, e.g., fibrous polysaccharides, for use in the present invention include, but are not limited to, chitin which is a major component of arthropod exoskeletons, hyaluronic acid which is found in extracellular space and cartilage (e.g., D-glucuronic acid which is a component of hyaluronic acid, D-N-acetylglucosamine which is a component of hyaluronic acid, etc.), etc.

In one embodiment, the polymers may be mixtures of two or more polymers and/or two or more copolymers. In one embodiment, the polymers may be a mixture of one or more polymers and or more copolymers. In another embodiment, the polymers for use in the devices and methods of the invention may be a mixture of one or more synthetic polymers and one or more naturally occurring polymers. For example, in one embodiment, the polymers are a mixture of collagen and polycarpolactone. In another embodiment, the polymers are a hybrid of poly-4-hydroxybutyrate (P4HB), polyglycolic acid (PGA), and gelatin/collagen. In yet another embodiment, the polymers are a mixture of polycaprolactone and gelatin, e.g., uncrosslinked gelatin.

Examples of polymers that can be employed for fiber formation that are well suited for use in articles of clothing include, but are not limited to, nylon, polyester, acrylic, lycra/spandex/elastane, Kevlar, acetate, and rayon.

In some embodiments, suitable devices and uses of the devices for fabricating the micron, submicron or nanometer dimension polymeric fibers for use in the present invention are described in U.S. Pat. No. 9,410,267, and U.S. Patent Publication No. 2013/0312638, the entire contents of each of which are incorporated herein by reference.

For example, in some embodiments, suitable devices for fabricating the micron, submicron or nanometer dimension polymeric fibers configured in a desired shape generally include a reservoir for holding a polymer, the reservoir including one or more orifices for ejecting the polymer during fiber formation, thereby forming a micron, submicron or nanometer dimension polymeric fiber and a collection device, e.g., a mandrel, for accepting the formed micron, submicron or nanometer dimension polymeric fiber, wherein at least one of the reservoir and the collection device employs rotational motion during fiber formation, and the device is free of an electrical field, e.g., a high voltage electrical field.

The device may include a rotary motion generator for imparting a rotational motion to the reservoir and, in some exemplary embodiments, to the collection device. In some embodiments, a flexible air foil is attached to a shaft of the motor above the reservoir to facilitate fiber collection and solvent evaporation.

Rotational speeds of the reservoir in exemplary embodiments may range from about 1,000 rpm-60,000 rpm, about 1,000 rpm-50,000 rpm, about 1,000 rpm to about 40,000 rpm, about 1,000 rpm-30,000 rpm, about 1,000 rpm to about 20,000 rpm, about 1,000 rpm-10,000 rpm, about 5,000 rpm-60,000 rpm, about 5,000 rpm-50,000 rpm, about 5,000 rpm to about 40,000 rpm, about 5,000 rpm-30,000 rpm, about 5,000 rpm-20,000 rpm, about 5,000 rpm to about 15,000 rpm, about 5,000 rpm-10,000 rpm, about 10,000 rpm-60,000 rpm, about 10,000 rpm-50,000 rpm, about 10,000 rpm to about 40,000 rpm, about 10,000 rpm-30,000 rpm, about 10,000 rpm-20,000 rpm, about 10,000 rpm to about 15,000 rpm, about 20,000 rpm-60,000 rpm, about 20,000 rpm-50,000 rpm, about 20,000 rpm to about 40,000 rpm, about 20,000 rpm-30,000 rpm, or about 50,000 rpm to about 400,000 rpm, e.g., about 1,000, 1,500, 2,000, 2,500, 3,000, 3,500, 4,000, 4,500, 5,000, 5,500, 6,000, 6,500, 7,000, 7,500, 8,000, 8,500, 9,000, 9,500, 10,000, 10,500, 11,000, 11,500, 12,000, 12,500, 13,000, 13,500, 14,000, 14,500, 15,000, 15,500, 16,000, 16,500, 17,000, 17,500, 18,000, 18,500, 19,000, 19,500, 20,000, 20,500, 21,000, 21,500, 22,000, 22,500, 23,000, 23,500, 24,000, 25,000, 26,000, 27,000, 28,000, 29,000, 30,000, 31,000, 32,000, 33,000, 34,000, 35,000, 36,000, 37,000, 38,000, 39,000, 40,000, 41,000, 42,000, 43,000, 44,000, 45,000, 46,000, 47,000, 48,000, 49,000, 50,000, 55,000, 60,000, 65,000, 70,000, 75,000, 80,000, 85,000, 90,000, 95,000, 100,000, 105,000, 110,000, 115,000, 120,000, 125,000, 130,000, 135,000, 140,000, 145,000, 150,000 rpm, about 200,000 rpm, 250,000 rpm, 300,000 rpm, 350,000 rpm, or 400,000 rpm. Ranges and values intermediate to the above recited ranges and values are also contemplated to be part of the invention.

In certain embodiments, rotating speeds of about 50,000 rpm-400,000 rpm are intended to be encompassed by the methods of the invention. In one embodiment, devices employing rotational motion may be rotated at a speed greater than about 50,000 rpm, greater than about 55,000 rpm, greater than about 60,000 rpm, greater than about 65,000 rpm, greater than about 70,000 rpm, greater than about 75,000 rpm, greater than about 80,000 rpm, greater than about 85,000 rpm, greater than about 90,000 rpm, greater than about 95,000 rpm, greater than about 100,000 rpm, greater than about 105,000 rpm, greater than about 110,000 rpm, greater than about 115,000 rpm, greater than about 120,000 rpm, greater than about 125,000 rpm, greater than about 130,000 rpm, greater than about 135,000 rpm, greater than about 140,000 rpm, greater than about 145,000 rpm, greater than about 150,000 rpm, greater than about 160,000 rpm, greater than about 165,000 rpm, greater than about 170,000 rpm, greater than about 175,000 rpm, greater than about 180,000 rpm, greater than about 185,000 rpm, greater than about 190,000 rpm, greater than about 195,000 rpm, greater than about 200,000 rpm, greater than about 250,000 rpm, greater than about 300,000 rpm, greater than about 350,000 rpm, or greater than about 400,000 rpm.

Exemplary devices employing rotational motion may be rotated for a time sufficient to form a desired polymeric fiber, such as, for example, about 1 minute to about 100 minutes, about 1 minute to about 60 minutes, about 10 minutes to about 60 minutes, about 30 minutes to about 60 minutes, about 1 minute to about 30 minutes, about 20 minutes to about 50 minutes, about 5 minutes to about 20 minutes, about 5 minutes to about 30 minutes, or about 15 minutes to about 30 minutes, about 5-100 minutes, about 10-100 minutes, about 20-100 minutes, about 30-100 minutes, or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 minutes, or more. Times and ranges intermediate to the above-recited values are also intended to be part of this invention.

In some embodiments, the reservoir may not be rotated, but may be pressurized to eject the polymer material from the reservoir through one or more orifices. For example, a mechanical pressurizer may be applied to one or more surfaces of the reservoir to decrease the volume of the reservoir, and thereby eject the material from the reservoir. In another exemplary embodiment, a fluid pressure may be introduced into the reservoir to pressurize the internal volume of the reservoir, and thereby eject the material from the reservoir.

An exemplary reservoir may have a volume ranging from about one nanoliter to about 1 milliliter, about one nanoliter to about 5 milliliters, about 1 nanoliter to about 100 milliliters, or about one microliter to about 100 milliliters, for holding the liquid material. Some exemplary volumes include, but are not limited to, about one nanoliter to about 1 milliliter, about one nanoliter to about 5 milliliters, about 1 nanoliter to about 100 milliliters, one microliter to about 100 microliters, about 1 milliliter to about 20 milliliters, about 20 milliliters to about 40 milliliters, about 40 milliliters to about 60 milliliters, about 60 milliliters to about 80 milliliters, about 80 milliliters to about 100 milliliters, but are not limited to these exemplary ranges. Exemplary volumes intermediate to the recited volumes are also part of the invention. In certain embodiment, the volume of the reservoir is less than about 5, less than about 4, less than about 3, less than about 2, or less than about 1 milliliter. In other embodiments, the physical size of an unfolded polymer and the desired number of polymers that will form a fiber dictate the smallest volume of the reservoir.

In one embodiment, a polymer is fed into a reservoir as a fiber-forming liquid, which, in some embodiments, is a polymer solution that includes nanocapsules and microcapsules, i.e., a polymer dissolved in an appropriate solvent in which nanocapsules and microcapsules are also present forming a solution. In this embodiment, the methods may further comprise dissolving the polymer in a solvent prior to feeding the solution into the reservoir.

The reservoir includes one or more orifices through which one or more jets of the fiber-forming liquid (e.g., polymer solution) are forced to exit the reservoir by the motion of the reservoir during fiber formation. One or more exemplary orifices may be provided on any suitable side or surface of the reservoir including, but not limited to, a bottom surface of the reservoir that faces the collection device, a side surface of the reservoir, a top surface of the reservoir that faces in the opposite direction to the collection device, etc. Exemplary orifices may have any suitable cross-sectional geometry including, but not limited to, circular, oval, square, rectangular, etc. In an exemplary embodiment, one or more nozzles may be provided associated with an exemplary orifice to provide control over one or more characteristics of the fiber-forming liquid exiting the reservoir through the orifice including, but not limited to, the flow rate, speed, direction, mass, shape and/or pressure of the fiber-forming liquid. The locations, cross-sectional geometries and arrangements of the orifices on the reservoir, and/or the locations, cross-sectional geometries and arrangements of the nozzles on the orifices, may be configured based on the desired characteristics of the resulting fibers and/or based on one or more other factors including, but not limited to, viscosity of the fiber-forming liquid, the rate of solvent evaporation during fiber formation, etc.

Exemplary orifice lengths that may be used in some exemplary embodiments range between about 0.001 m and about 0.05 m, e.g., 0.0015, 0.002, 0.0025, 0.003, 0.0035, 0.004, 0.0045, 0.005, 0.0055, 0.006, 0.0065, 0.007, 0.0075, 0.008, 0.0085, 0.009, 0.0095, 0.01, 0.015, 0.02, 0.025, 0.03, 0.035, 0.04, 0.045, or 0.05. In some embodiments, exemplary orifice lengths that may be used range between about 0.002 m and 0.01 m. Ranges and values intermediate to the above recited ranges and values are also contemplated to be part of the invention.

Exemplary orifice diameters that may be used in some exemplary embodiments range between about 0.1 μm and about 10 μm, about 50 μm to about 500 μm, about 200 μm to about 600 μm, about 200 μm to about 1,000 μm, about 500 μm to about 1,000 μm, about 200 μm to about 1,500 μm, about 200 μm to about 2,000 μm, about 500 μm to about 1,500 μm, or about 500 μm to about 2,000 μm, e.g., about 10, 20, 30, 40, 50, 100, 150, 200, 250, 300, 350, 400, 450, 500, 550, 600, 650, 700, 750, 800, 850, 900, 950, 1,000, 1,050, 1,100, 1,150, 1,200, 1,250, 1,300, 1,350, 1,400, 1,450, 1,500, 1,550, 1,600, 1,650, 1,700, 1,750, 1,800, 1,850, 1,900, 1,950, or about 2,000 μm. Ranges and values intermediate to the above recited ranges and values are also contemplated to be part of the invention.

In other embodiments, a suitable device for the formation of a micron, submicron or nanometer dimension polymeric fibers includes a reservoir for holding a polymer, the reservoir including one or more orifices for ejecting the polymer during fiber formation, thereby forming micron, submicron or nanometer dimension polymeric fibers, a collection device, e.g., a mandrel, and an air vessel for circulating a vortex of air around the formed fibers to wind the fibers into one or more threads.

In yet other embodiments, a suitable device for the formation of a micron, submicron or nanometer dimension polymeric fiber includes a reservoir for holding a polymer, the reservoir including one or more orifices for ejecting the polymer during fiber formation, thereby forming a micron, submicron or nanometer dimension polymeric fiber, a collection device, e.g., a mandrel, one or more mechanical members disposed or formed on or in the vicinity of the reservoir for increasing an air flow or an air turbulence experienced by the polymer ejected from the reservoir, and a collection device for accepting the formed micron, submicron or nanometer dimension polymeric fiber.

In one embodiment, a suitable device further comprises a component suitable for continuously feeding the polymer into the rotating reservoir (or a platform), such as a spout or syringe pump.

An exemplary method to fabricate the micron, submicron or nanometer dimension polymeric fibers configured in a desired shape (e.g., a tubular shape, a shape of an article of clothing like a sock, or a shape of a portion of a body) may include imparting rotational motion to a reservoir holding a polymer, the rotational motion causing the polymer to be ejected from one or more orifices in the reservoir and collecting the formed fibers on a mandrel having the desired shape, to form the micron, submicron or nanometer dimension polymeric fibers in the desired shape.

In one embodiment, the methods include feeding a polymer into a rotating reservoir of a device of the invention and providing motion at a speed and for a time sufficient to form a micron, submicron or nanometer dimension polymeric fiber, and collecting the formed fibers on a mandrel having the desired shape, to form the micron, submicron or nanometer dimension polymeric fibers in the desired shape.

In another embodiment, the methods include those of U.S. Pat. No. 9,738,046, the entire contents of which are incorporated herein by reference, and include providing a fiber forming liquid and imparting a sufficient amount of shear stress to the polymer solution for a time sufficient to form a micron, submicron or nanometer dimension polymeric fiber, and collecting the formed fibers on a mandrel having the desired shape, to form the micron, submicron or nanometer dimension polymeric fibers in the desired shape. In one embodiment, a sufficient amount of shear stress in about 3,000 Pascals.

In another embodiment, the methods include feeding a polymer solution into a rotating reservoir of a device of the invention and providing an amount of shear stress to the rotating polymer solution for a time sufficient to form a micron, submicron or nanometer dimension polymeric fiber, and collecting the formed fibers on a mandrel having the desired shape, to form the micron, submicron or nanometer dimension polymeric fibers in the desired shape.

In another embodiment, the methods include those described in U.S. Patent Publication No. 2015/0354094, the entire contents of which are incorporated herein by reference, which include, providing a device for formation of one or more micron, submicron or nanometer dimension polymeric fibers, the device comprising a reservoir for holding a polymer and including a surface having one or more orifices for ejecting the polymer for fiber formation, wherein the polymer is selected from the group consisting of a polymer that requires on-contact cross-linking, a polymer that cannot be readily dissolved at a high enough concentrations to provide sufficient viscosity for random entanglement and solvent evaporation to form polymeric fibers, and a polymer that requires precipitation; a motion generator configured to impart rotational motion to the reservoir, the rotational motion of the reservoir causing ejection of the polymer through the one or more orifices; and a collection device holding a liquid, the collection device configured and positioned to accept the polymer ejected from the reservoir; wherein the reservoir and the collection device are positioned such that the one or more orifices of the reservoir are submerged in the liquid in the collection device during rotation of the reservoir to eject the polymer; and wherein the ejection of the polymer into the liquid in the collection device causes formation of one or more micron, submicron or nanometer dimension polymeric fibers.

Use of such devices for preparation of polymeric fibers for use in the present invention include using the motion generator to rotate the reservoir about an axis of rotation to cause ejection of the polymer in one or more jets; and collecting the one or more jets of the polymer in the liquid held in the collection device to cause formation of the one or more micron, submicron or nanometer dimension polymeric fibers.

In another embodiment, a suitable device for formation of one or more micron, submicron or nanometer dimension polymeric fibers, the device comprising a reservoir for holding a polymer and including an outer surface having one or more orifices for ejecting the polymer for fiber formation; a first motion generator couplable to the reservoir, the first motion generator configured to impart rotational motion to the reservoir to cause ejection of the polymer through the one or more orifices; and a collection device holding a liquid, the collection device configured and positioned to accept the polymer ejected from the reservoir; a second motion generator couplable to the collection device, the second motion generator configured to impart rotational motion to the liquid in the collection device to generate a liquid vortex including an air gap; wherein the reservoir and the collection device are positioned such that the one or more orifices of the reservoir are positioned in the air gap of the liquid vortex in the collection device; and wherein the ejection of the polymer into the air gap and subsequently into the liquid of the liquid vortex in the collection device causes formation of one or more micron, submicron or nanometer dimension polymeric fibers.

Use of such devices for preparation of polymeric fibers for use in the present invention include using the first motion generator to rotate the reservoir about an axis of rotation to cause ejection of the polymer in one or more jets; using the second motion generator to rotate the liquid in the collection device to generate the liquid vortex; and collecting the one or more jets of the polymer in the air gap of the liquid vortex and subsequently in the liquid of the liquid vortex of the collection device to cause formation of the one or more micron, submicron or nanometer dimension polymeric fibers.

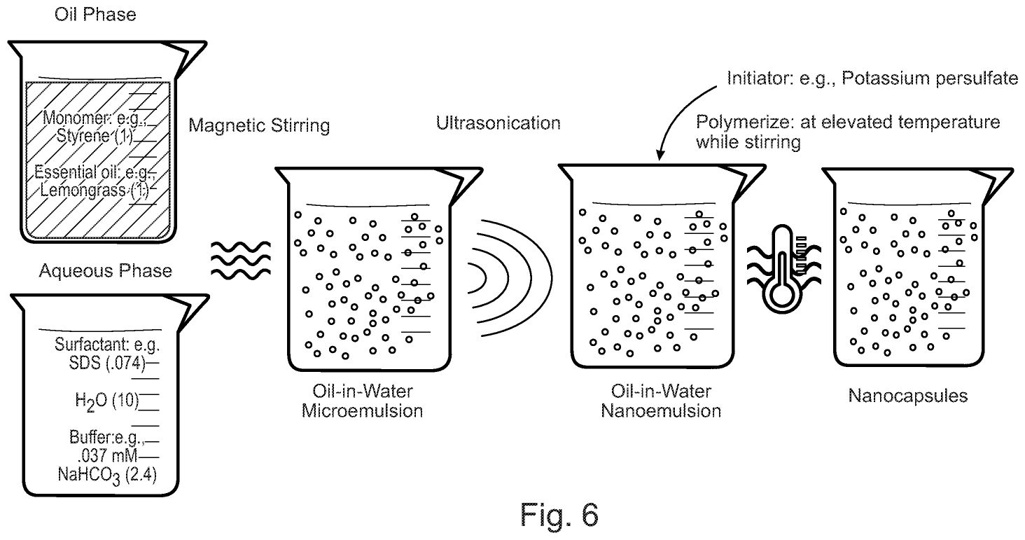

In some embodiments, the methods the methods of manufacturing a material further include making the microcapsules or nanocapsules. In some embodiments, miniemulsion polymerization is employed to create the microcapsules or nanocapsules. A process for making microcapsules or nanocapsules by miniemulsion polymerization is schematically depicted in FIG. 6. An oil phase including a monomer (e.g., styrene) or polymer and an essential oil (e.g., lemongrass) is mixed with an aqueous phase including a surfactant (e.g., sodium dodecyl sulfate (SDS)), water, and a buffer (e.g., sodium bicarbonate) to form a solution. After mixing the solution is magnetically stirred forming an emulsion with micron sized droplets. The microemulsion is then sonicated to form an oil in water nanoemulsion. The nanoemulsion is heated and then an initiator is added to begin the polymerization reaction. In some embodiments, the nanoemulsion is kept in an low oxygen or oxygen free atmosphere during some or all of the polymerization. In some embodiments, the nanoemulsion is stirred during part of all of the polymerization. The result of the polymerization is nanocapsules having a polymer outer shell surrounding an essential oil.

Examples of polymers that can be used to form a polymer shell for encapsulating an essential oil include, but are not limited to, polystyrene, poly-Divinylbenzene, and PGA.

This invention is further illustrated by the following examples, which should not be construed as limiting. The entire contents of all references, patents and published patent applications cited throughout this application, as well as the Figures, are hereby incorporated herein by reference.

### EXAMPLES

### Example 1: Designing and Determining Capsule Diameter

The inventors considered multiple different criteria in determining what size microparticles or nanoparticles to employ in example materials and developed methods of making the microparticles or nanoparticles having a controlled diameter.

Since radius ultimately has no effect on the area of fabric covered or the total weight of nanocapsules necessary, other criteria were used to constrain the particle size. The nanocapsule diameter was carefully determined and controlled to predict performance and ensure safety.

A major concern is dermal delivery or absorption of the polystyrene nanocapsules through the skin. While polystyrene and lemongrass are not toxic at the dose applied from the disclosed invention, a small nanocapsule could be absorbed into living skin, blood and subsequently build up in hydrophobic fat in human tissue. There is a small concern that released nanocapsules will be able to enter the skin, penetrate through the stratum corneum and enter the blood stream causing potential harm. If a sufficient number of polystyrene particles were broken down into carcinogenic styrene, it could cause harmful effects. A dose of styrene (dose at which 50% of the population died) is 0.2 mg per kilogram body weight per day or approximately 13 mg, which represents approximately 0.5% of the weight of nanocapsules within an article of clothing disclosed herein.

Silver nanoparticles of 40 nm were able to penetrate through to the dermal layer, beneath the subcutaneous layer, by entering the hair follicle (Vogt, A. et al., (2006). J. Invest. Dermatol. 126: 1316-1322). In the case of damaged skin, the rate of absorption increased by 5 times. Of particles below 100 nm in diameter, a small percentage of total particle concentration in blood (4-7%) has been found in the blood-filtering organs such as the liver and the spleen (Hoet P. H. et al. (2004) J. of Nanobiotechnology. 2004; 2:12). However, particles with diameters greater than 100 nm do not reach the tissue in significant concentrations and those larger than 300 nm are quickly cleared from the blood. These concerns set the minimum diameter at 100 nm or larger.

To establish the maximum diameter limit, a proof-of-concept test was conducted with commercially purchased polystyrene nanobeads of size 800 nm and 1750 nm. The maximum size of nanobeads that was successfully incorporated into nanofibers was approximately 900 nm. This leaves a concise preferred diameter range of 100-300 nm and a potential diameter range of 100-900 nm. Aside from this, a low polydispersity (PDI) index or distribution of nanoparticle size allows determination and control of diffusion rate of lemongrass oil from nanocapsules.

The inventors selected polystyrene as the material for encapsulating the essential oil in the nanoparticles using a polymer shell. For this example, the essential oil was encapsulated in a polymer shell and so the nanoparticles are referred to as nanocapsules. However, one of ordinary skill in the art will appreciate that in other embodiments, the essential oil may be distributed throughout the nanoparticle or another suitable configuration may be employed.

Divinylbenzene (DVB), is a versatile cross-linking agent which is similar in structure to styrene with an additional vinyl group. When cross-linked with polystyrene DVB increases solvent resistance, heat distortion, and hardness. A small weight percentage (such as 0.5%) is enough to make polystyrene insoluble. However, polymers containing a very small amount of DVB will swell up to 20 times their volume. This could lead to poor encapsulation results as the polymer shell may swell up with lemongrass oil allowing the quick diffusion of lemongrass.

In this invention, it was hypothesized that increasing the content of DVB would lead to a smaller size distribution, smaller nanocapsules—as the polymer would be more tightly and rigidly packed—and additionally slow diffusion time of lemongrass oil as there would be greater steric hindrance and molecular interaction between the crosslinking groups and compounds in the oil.

Nanocapsules having a polystyrene outer shell encapsulating lemongrass oil were made using the miniemulsion polymerization method depicted in FIG. 6. A similar method without the lemongrass oil was used to prepare solid polystyrene nanobeads as a control. For the nanocapsules with a polystyrene outer shell encapsulating lemongrass, an oil phase including a 1:1 molecular ratio of styrene to lemongrass oil was mixed with an aqueous phase to form a solution. The aqueous phase included SDS as a surfactant, water and sodium bicarbonate (NaHCO₃) as a buffer.

Specifically, 1 g of styrene was passed through an alumina column and refrigerated until use within one hour. Surfactant SDS, the initiator KPS, sodium bicarbonate, and lemongrass oil were purchased from Sigma-Aldrich. Deionized water was used for all experiments. To prepare the pre-emulsion, 74 mg SDS and 2.4 mL of 0.037 mM sodium bicarbonate were dissolved in 10 mL water. This aqueous phase was then added to the oil phase of 1 g of monomer styrene and 1 g of lemongrass.

After mixing the solution was magnetically stirred at 1000 rotations per minute (RPM) for about two and a half hours which produced a emulsion with micron sized droplets. The microemulsion was then sonicated for about 8 minutes at about 20 kHz under ice cooling forming a nanoemulsion. An initiator, specifically potassium persulfate (KPA) was added to begin the polymerization reaction and polymerization was performed for 12 hours at 80° C. with magnetic stirring at 250 RPM. Before heating, excess of water with equivalent concentration of surfactant and sodium bicarbonate was added as had been stipulated in other miniemulsion polymerization protocols. The polymerization reaction was conducted in a nitrogen environment created by bubbling the nanoemulsion in alternating nitrogen then reduced pressure environments for 15 minutes a piece until 2 hours had passed and then conducting polymerization reaction in nitrogen environment. The relative molecular concentrations of the various materials used appear in the table below.

| Styrene | Lemongrass oil | SDS | H₂O | NaHCO₃ | KPS |
|---|---|---|---|---|---|
| 1 | 1 | 0.015 | 10 | 0.0042 | 0.017 |

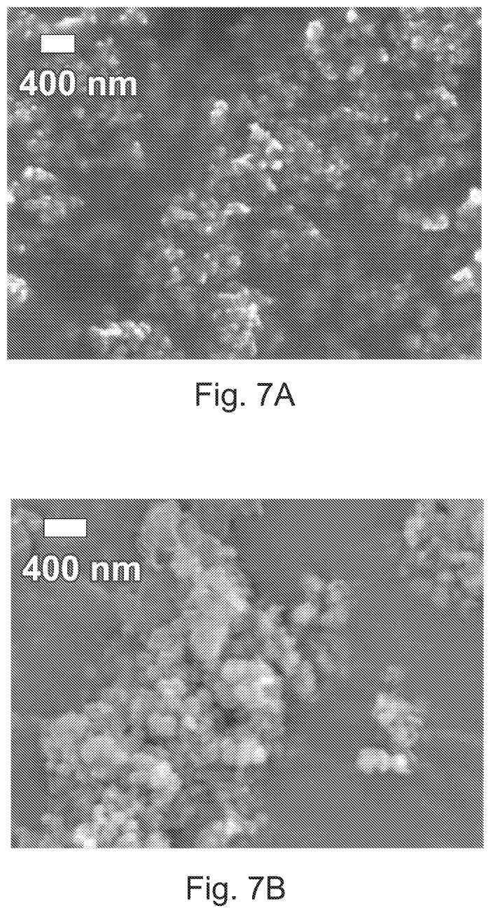

FIG. 7A is an SEM image of solid polystyrene nanobeads that were produced and FIG. 7B is an SEM image of lemongrass-polystyrene nanocapsules that were produced. Although the particles produced are referred to as nanobeads and nanocapsules in some portions herein, it should be noted that some of the particles had a diameter greater than 1 μm.

In addition to producing lemongrass/polystyrene microcapsules and nanocapsules as described above, solid polystyrene microbeads and nanobeads were produced. Further, for some nanocapsules, divinylbenzene (DVB) was added to improve cross-linking during polymerization. Styrene, lemongrass (LG), deionized water, SDS, sodium bicarbonate, and KPS were used as described above. Divinylbenzene with 80% purity was obtained from Aldrich. 0.1, 0.2 and 0.3 g of divinylbenzene (DVB) was used to make 0, 10, 20 and 30 wt % (or weight with respect to styrene) oil phase solutions. Divinylbenzene was washed with 1 N NaOH three times then deionized water three times using a separation funnel to remove the inhibitor tert-butylcatechol. The amount of KPS was scaled to match the weight of styrene and divinylbenzene as outlined in the table below. The amount of lemongrass was kept consistent at 100 wt % with respect to styrene as the content of lemongrass in styrene needed to be maximized to maximize lifetime of the product. A 1:1 weight ratio of core material to shell material the highest ratio that successfully produced nanocapsules. A greater ratio of essential oil to polystyrene (PS) shell lead to an unstable emulsion, which was not successfully converted into a nanocapsule.

Weight (g) of solution components for miniemulsion
polymerization of nanocapsules

| Nanocapsule | Styrene | LG | DVB | SDS | KPS | H₂O | NaHCO₃ |
|---|---|---|---|---|---|---|---|
| Solid PS | 2 | 0 | — | .015 | .017 | 10 | .0042 |
| 1:1 PS LG | 1 | 1 | — | .015 | .017 | 10 | .0042 |
| 1:1:0.1 PS LG | 1 | 1 | 0.1 | .015 | .017 | 10 | .0042 |
| DVB | | | | | | | |
| 1:1:0.2 PS LG | 1 | 1 | 0.2 | .015 | .017 | 10 | .0042 |
| DVB | | | | | | | |
| 1:1:0.3 PS LG | 1 | 1 | 0.3 | .015 | .017 | 10 | .0042 |
| DVB | | | | | | | |

The average diameter and particle size distribution of nanocapsules and nanobeads produced was determined using dynamic light scattering (DLS). When a light beam comes into contact with particles in a carrying medium (water in this case), the degree of light scattering can be used to determine the diameter of the nanocapsules and nanobeads. Analysis of DLS measurements yielded the number distribution and size distribution of nanoparticles as well as the PDI, a measure of nanoparticle diameter variance. A PDI of 1 implies unity of particle size and PDI increases for increased distribution. A Beckman Coulter DelsaNano C Particle and Zeta Potential analyzer was used to conduct DLS.

The samples were prepared for DLS analysis with 10% dilution and made with fresh deionized water. Each analysis was carried out in triplicate and 100 particles were assessed.

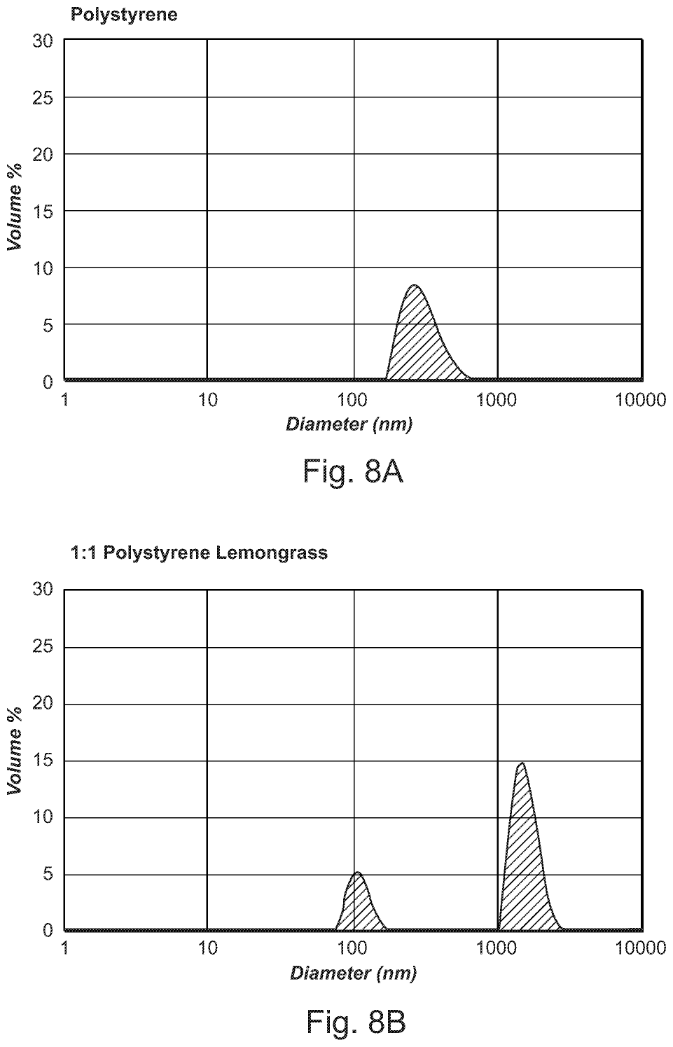

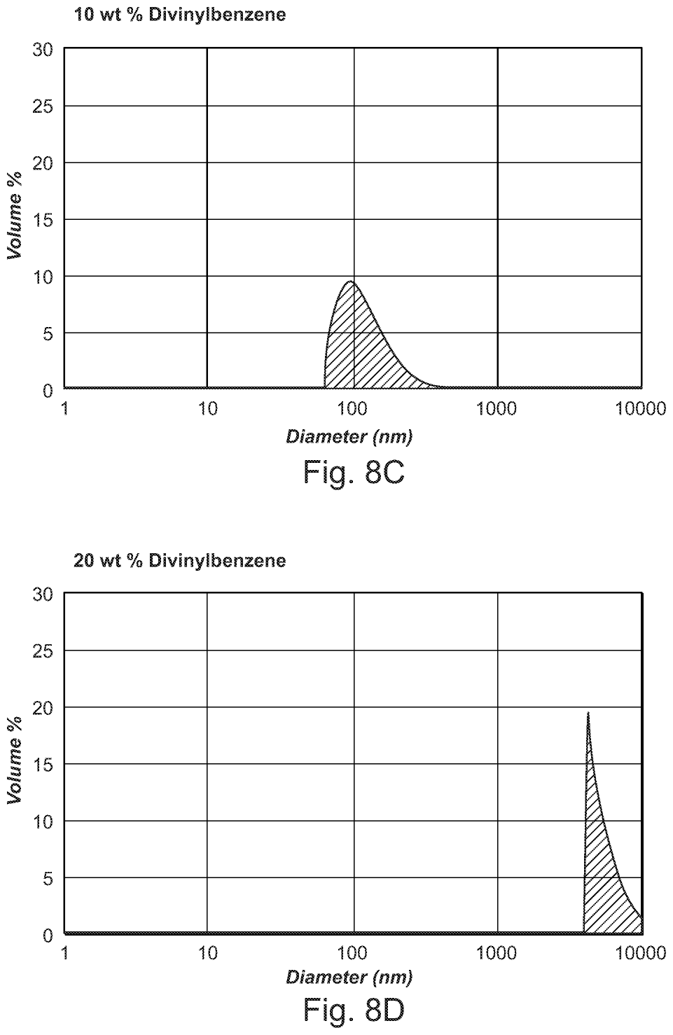

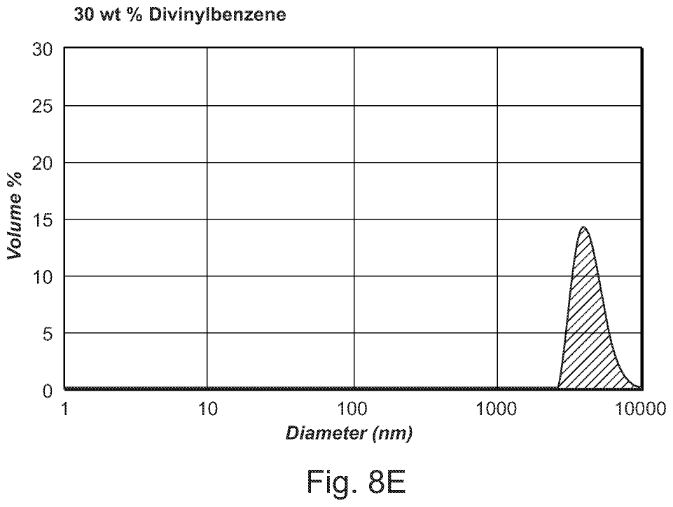

FIG. 8A is a graph of the volume distribution of solid PS microbeads and nanobeads produced using miniemulsion polymerization as measured using DLS. FIG. 8B is a graph of the volume distribution of microcapsules and nanocapsules made of 1:1 ratio of styrene to lemongrass as measured using DLS. FIG. 8C is a graph depicting the volume distribution of lemongrass-PS/DVB microcapsules and nanocapsules made with a 1:1 ratio of styrene to lemongrass and 10% wt DVB relative to styrene in the initial solution. FIG. 8D is a graph depicting the volume distribution of lemongrass-PS/DVB microcapsules and nanocapsules made of 20% wt DVB relative to styrene in the initial solution.

While polystyrene nanobeads and 10 wt % DVB nanocapsules had a unimodal volume distribution and a diameter of approximately 100 nm diameter; 20 wt % DVB nanocapsules had unimodal distribution with a large average diameter of approximately 5000 nm. The 1:1 LG-PS nanocapsules and the 30 wt % LG-PS/DVB nanocapsules had bimodal distributions. While LG-PS nanocapsules had a peak at a useful diameter (about 100 nm), the 30 wt % DVB LG-PS/DVB nanocapsules peak at far too large a diameter at approximately 10,000 nm. The diameters and PDIs are summarized in the table below.

Distribution of nanocapsule diameters
and their respective PDI using DLS

| | Number Peak | Volume Peak | Average | |
|---|---|---|---|---|
| Nanocapsule | Diameter | Diameter | Diameter | PDI |
| Solid PS | 216.2 | 259.0 | 362.2 | 1.088 |
| 1:1 PS LG | 101.7 | 1506.9 | 572.1 | 1.445 |
| 10 wt % DVB | 67.9 | 94.6 | 200.7 | 1.1239 |
| 20 wt % DVB | 191.5 | 4249.1 | 742.2 | 1.307 |
| 30 wt % DVB | 128.5 | 3825.7 | 2800.9 | 1.785 |

The nanocapsules that matched the preferred diameter range of 100-300 nm were 10 wt % DVB nanocapsules as they had an average diameter of 200.7 nm and the lowest PDI (1.12) of any lemongrass containing nanocapsule. As evidenced by the vastly differing volume peak diameter in 1:1 PS-LG, 20 wt % and 30 wt % DVB nanocapsules, there was a bimodal distribution in nanocapsule size. There are two potential reasons for the bimodal distribution (two peaks) observed. After sonication, the stability of the miniemulsion is controlled by a balance of osmotic pressure of the oil core-monomer system and the Laplace pressure of the droplets. In order for the emulsion to be stable, a net zero pressure must be established and there may have been two different emulsion diameters at which a net zero pressure was established. The bi-modal distribution may also be due to the insufficient degree of sonication or pockets of nanocapsules, which were not completely sonicated so remained as a micro-emulsion instead of reducing in diameter to a nanoscale emulsion. This is possible since the emulsions were not magnetically stirred during emulsification because of tool constraints within the laboratory. However, the emulsions were periodically stirred with a glass rod so the latter reason does not explain the disparity in number of microcapsules compared to nanocapsules.

### Example 2: Design, Preparation, and Characterization of Nanofibers

The inventors considered multiple different criteria in determining what nanofibers to employ in the creation of example materials and developed methods of making the material having nanofibers containing selected polymers and selected microparticles or nanoparticles.

Prior to fabricating nanocapsules, commercial polystyrene nanobeads were used to establish whether nanoparticles of any form could successfully be co-spun into nanofibers (e.g., PCL nanofibers) using the disclosed method and to determine if polystyrene nanoparticles would dissolve in the solvent employed for fiber production, specifically, hexafluoroisopropanol (HFIP).

0.8 μm PS nanobeads (5 w/v %) and 1.75 μm fluorospheres or fluorescent nanobeads (2.7 w/v %) were purchased from Sigma-Aldrich. HFIP was purchased from Oakwood Chemical. 6 v/v % solution of polycaprolactone (PCL) in HFIP was made prior and stirred overnight until dissolved. 10 pt of 0.8 μm nanobeads in solution was added to 6 mL of PCL in HFIP, 18.5 μL of the 1.75 μm fluorospheres. A control solution was created with no nanobeads. The mixed solution of polymer and nanobeads was briefly shaken by hand. The solutions were spun in according to the disclosed method with a 5 mL/min syringe infusion and reservoir rotational speed of 500 Hz onto a rotating drill set up with microscope slides covered in clear tape. The experiment was conducted twice. 3 samples were taken from each sample of nanofiber. The samples were analyzed using a Zeiss Ultra-55 Field Emission Scanning Electron Microscope (FESEM). To measure diameter, ImageJ software was used. To analyze and alter the images MATLAB edge detector and ImageJ Laplacian of Gaussian filters were used.

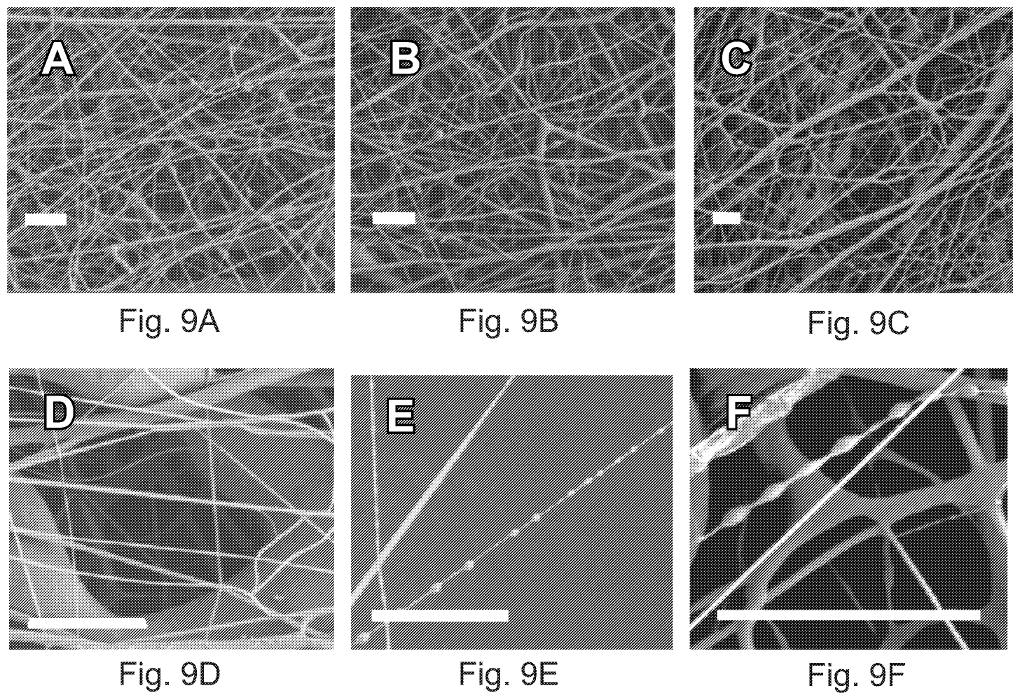

FIG. 9A is an SEM image of PCL nanofibers produced by spinning of a solution PCL in HFIP without nanobeads used as a control. FIG. 9B is an SEM image of PCL nanofibers incorporating solid 0.8 μm diameter PS nanobeads spun from a solution of 6 v/v % PCL in HFIP. FIG. 9C is a SEM image of PCL nanofibers incorporating 1.75 μm diameter fluorescent beads spun from a solution of 6 v/v % PCL in HFIP. FIG. 9D is a magnified view of FIG. 9A. FIG. 9E is a magnified view of FIG. 9B. FIG. 9F is a magnified view of FIG. 9C. 10 μm scale bars are provided for scale.

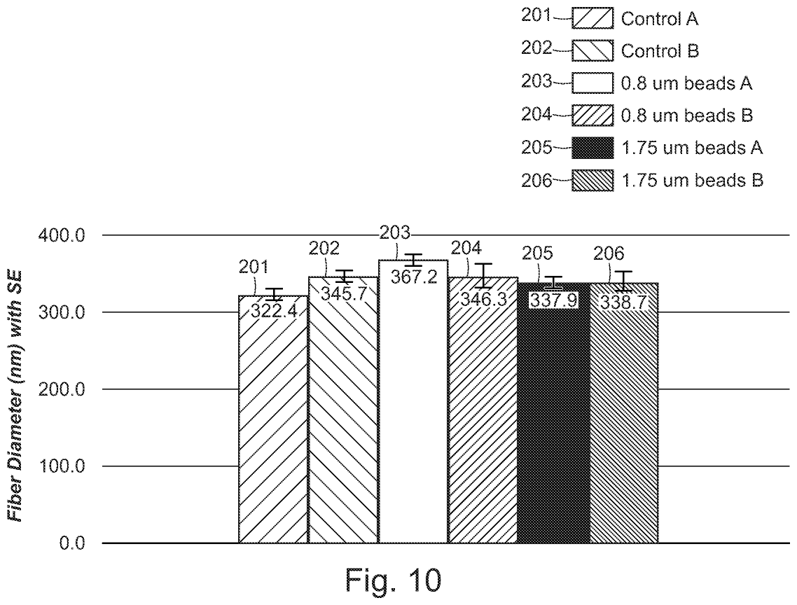

The nanobead and control solutions successfully spun into nanofibers. The appearance of regularly spaced beads in magnified images of the 0.8 μm small PS nanobead test and the 1.75 μm large PS nanobead test suggested that the nanobeads were successfully contained within nanofibers. The control PCL fibers without nanobeads spun as expected with high quality nanofibers and little beading. The 0.8 μm nanobead test nanofiber 2 were slightly wet on the first spin and appeared similar to the control PCL on the second spin. The 1.75 μm nanobead test nanofibers were very wet after spinning and clumpy in places suggesting poor mixing or adhesion between nanocapsules and nanofibers. This suggests that larger nanoparticles spin more poorly than small nanocapsules. To find the diameter of the nanofibers spun, ImageJ was used and 20-30 individual fibers were measured to get an n=100 estimate for the average nanofiber diameter and a standard error (SE). The diameters ranged from 322 to 367 nm and there was no significant relation between size of nanobeads added and resultant nanofiber diameter. FIG. 10 is a graph showing the measured fiber diameters of the various samples 201-206.

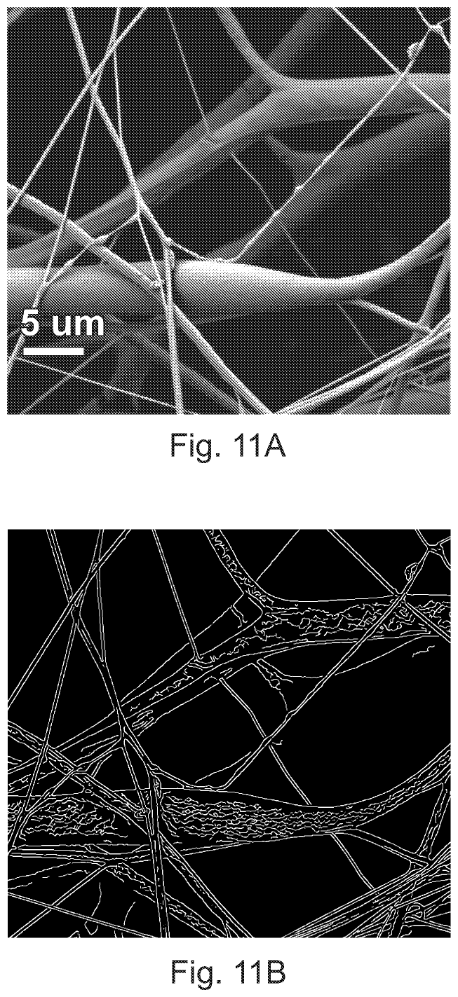

When analyzing the SEM images, it was difficult to ascertain the difference between nanocapsules and dust. In order to characterize the way nanobeads were incorporated in nanofibers and differentiate them from dust, a MATLAB Canny Edge Detector was used to analyze one image of 0.8 μm nanobeads. Nanofibers with PS nanobeads are depicted on in FIG. 11A and a Canny edge filtered version of FIG. 11A is depicted in FIG. 11B. Jagged edges indicate dust while curved edges indicate nanospheres. The edge filter retains strong edges and removes weak edges if they are not connected to a strong edge. In this case the weak edges of the curved microbeads disappear and the dust remains. This proves the theory that dust and nanoparticles have different characteristics. This also showed that nanobeads were continuous and contained within the nanofibers.

It was hypothesized that the fiber formation mechanism discussed above relied on the optimization of competing centrifugal forces and nozzle surface tension. This surface tension could cause jet instability and bead formation in nanofibers. To determine whether the observed beads originated from nanobeads or from beading in the nanofibers due to surface tension, control images were analyzed for the following nanofibers: control nanofibers including no nanoparticles or microparticles, 0.8 μm polystyrene nanobeads incorporated into nanofibers, and 1.75 μm polystyrene nanobeads incorporated into nanofibers.

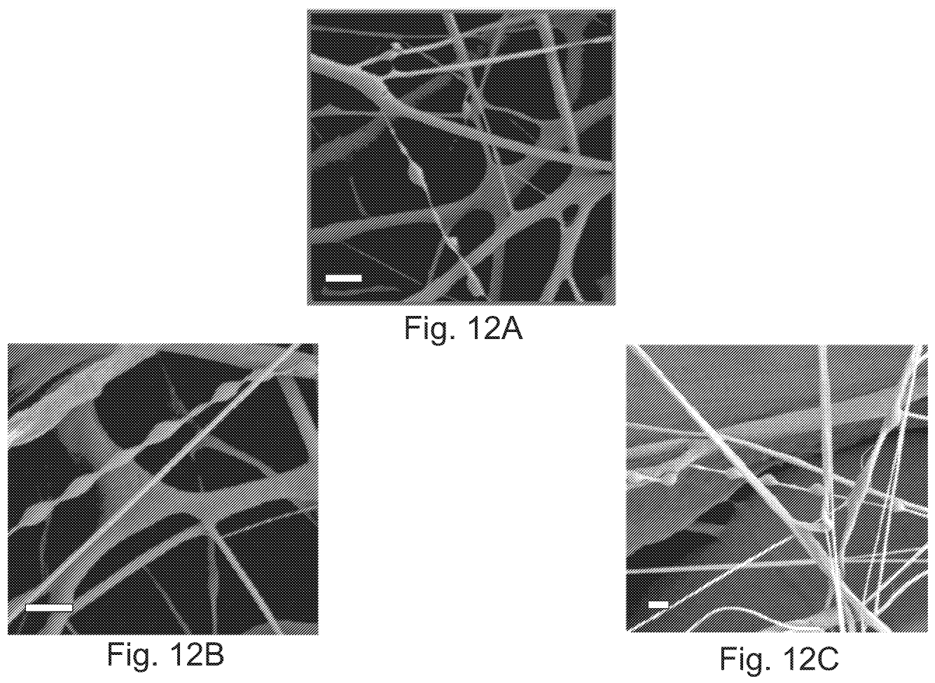

FIG. 12A is a SEM image of nanofibers without microparticles or nanoparticles. FIG. 12B is another SEM image of nanofibers without microparticles or nanoparticles. FIG. 12C is a SEM image of nanofibers incorporating 1.75 μm polystyrene nanobeads. As shown in FIGS. 12A-12C, beading in nanofibers had distinctly different characteristics than those attributed to nanobeads incorporated into nanofibers. Beading in a nanofiber is irregular with different sized beads visible on one fiber where nanobeads in a nanofiber have a consistent diameter. Additionally beading in nanofibers can be continuous rather than clearly spherical. This implies pooling of the nanofiber due to surface tension from the nozzle. In contrast, nanobeads incorporated in nanofibers appeared as separate entities on a nanofiber.

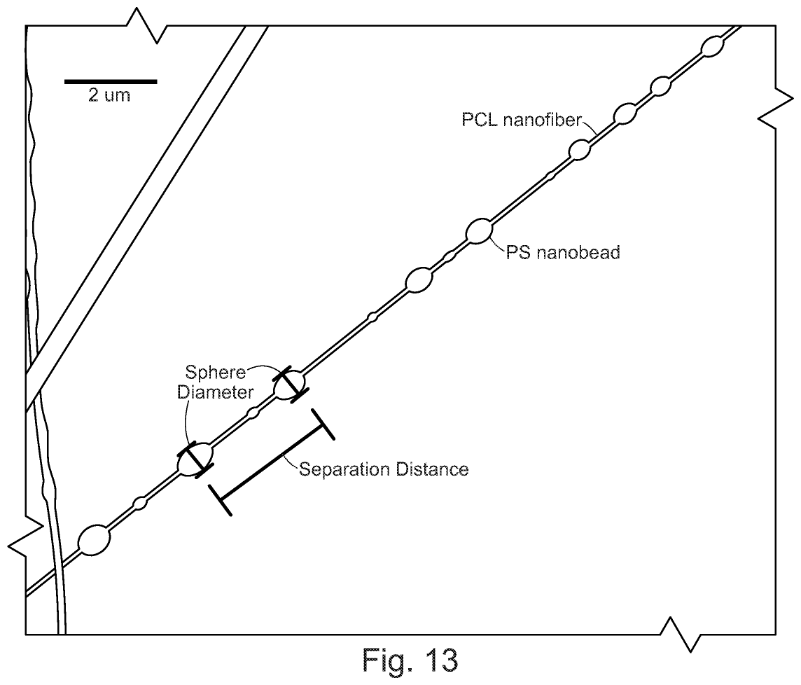

The SEM images of successfully co-spun nanocapsule-nanofibers were analyzed to assess whether there was a correlation between separation distance of nanobeads and the measured sphere diameter as indicated in an annotated image of a microfiber shown in FIG. 13.

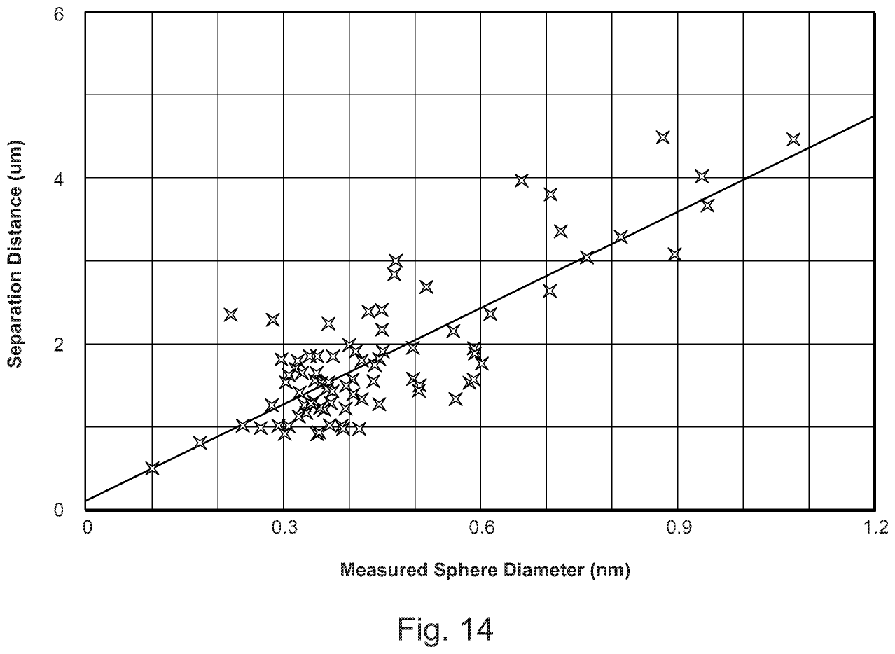

A linear relationship was found between measured sphere diameter and separation distance as shown in the graph in FIG. 14. Additionally no spheres above 1 μm in size were found contained within a nanofiber. Though this analysis was not exhaustive, as it is unlikely that all nanobeads contained within the nanofibers were located during imaging, conclusions can be drawn about the potential for nanofibers to contain nanocapsules. Firstly, smaller spheres are found closer together within nanofibers. Secondly, the nanocapsules with diameters similar to that of the nanofibers are most successfully contained. The reason why there are very few nanospheres observed below 300 nm is because the nanofiber width is approximately 300 nm so smaller nanospheres contained in nanofibers would not be observed.

### Example 3: Determining Weight Volume of Polymer Solution

The inventors hypothesized that increasing the weight volume of polymer in HFIP solution would create thicker nanofibers. Nanofiber thickness is an important parameter to increase as it can be used to further slow the diffusion rate of lemongrass oil from nanocapsules and fibers thereby extending the lifetime of the disclosed material.

Nylon 6 was obtained from Sigma-Aldrich. 6, 8, 10 and 12 v/v % solution of nylon in HFIP was made prior to the experiment and stirred overnight until dissolved. The solutions were spun in RJS with a 5 mL/min syringe infusion and reservoir rotational speed of 540 Hz onto a cylindrical container covered in aluminum foil. The experiment was conducted twice and three samples were taken from each sample of nanofibers. The samples were analyzed using a Zeiss Ultra-55 FESEM. ImageJ software was used to measure diameter.

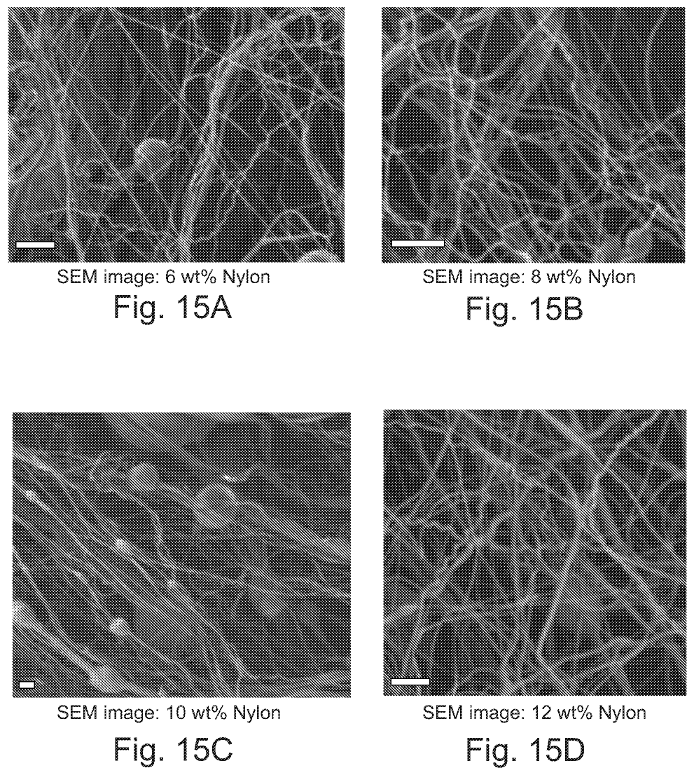

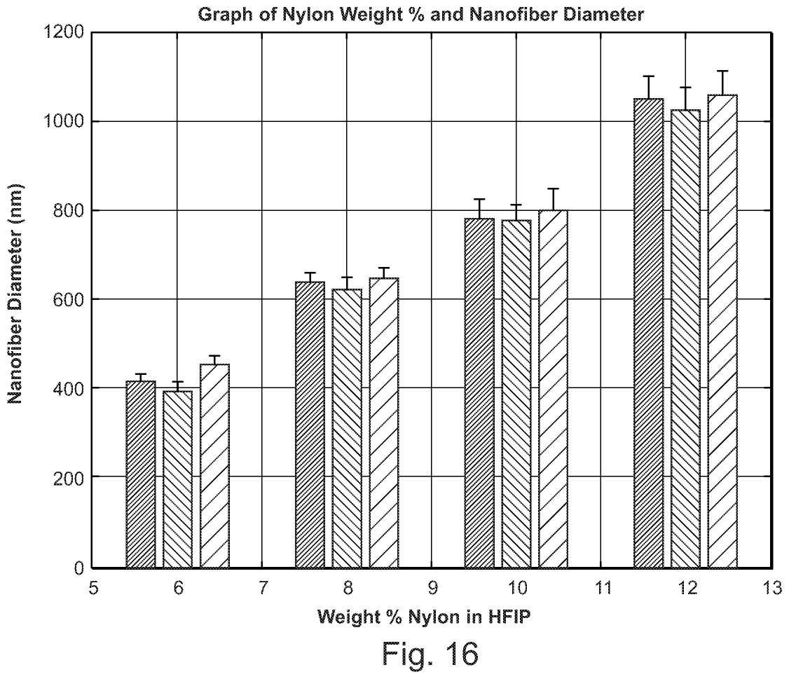

The diameter of nylon nanofibers was found to be proportional to the weight percent of nylon in HFIP solution. To reduce the rate of diffusion of oil out of the nanocapsules, in some embodiments a higher weight percent of nylon polymer solution can be co-spun with nanocapsules. SEM images were used to determine nanofiber diameter. FIG. 15A is an SEM image of a polymeric fiber spun from a solution of 6% nylon. FIG. 15B is an SEM image of a polymeric fiber spun from a solution of 8% nylon. FIG. 15C is an SEM image of a polymeric fiber spun from a solution of 10% nylon. FIG. 15D is an SEM image of a polymeric fiber spun from a solution of 12% nylon. The linear relationship between weight percent and nanofiber diameter is evident in FIG. 16.

### Example 4: Co-Spinning with Nanocapsules

After nanocapsules were fabricated and nanocapsules were successfully incorporated into nanofibers by co-spinning, these two components were combined in order to make a material, specifically, a non-woven polymeric sheet, including a plurality of polymeric fibers and a plurality of microcapsules or nanocapsules disposed in the plurality of polymeric fibers. An article of clothing was made from the non-woven polymeric fiber sheet. Nylon was used for the nanofibers as the material is commonly found in socks and so was more appropriate than PCL.

An important consideration is the load capacity of nanocapsules within nanofibers. The duration of anti-microbial activity is relating to the total load capacity of the nanocapsules within the nanofibers. If the nanofibers have only a 10% relative weight of nanocapsules, this would make the fiber properties more short-lived than if the nanofibers have a 20% relative weight of nanocapsules, and a greater weight of nanofibers would be required within an article of clothing in order to obtain the effective anti-microbial properties of lemongrass. In order to test this load capacity, varying ratios of nanocapsule solution and nanofiber polymer solution were mixed and the resulting essential oil content and nanofiber yield were assessed.

10 wt % DVB LG-PS nanocapsules were prepared as detailed above and added to water to make a 20 wt % solution of nanocapsules. 20 wt % nylon in HFIP solution was prepared and stirred until dissolved overnight. This nylon polymer solution was a greater weight percentage than had previously been tested because the addition of water and nanocapsules was expected to dilute the polymer solution by up to 50%. Different ratios of nanocapsule solution to nanofiber solution were prepared as follows: 1:1, 1:2, 1:4 and 1:9. These ratios were created to determine if there was a limit to the potential loading of nanocapsules within nanofibers. Higher ratios of nanocapsule to polymer led to extremely poor spinning, sputtering, and wet nanofibers and were therefore not successfully created or tested. The mixed solutions were prepared just before use, shaken briefly by hand and immediately used in the disclosed spinning method to create nanofibers.

When the nanocapsule solution and nanofiber solution were mixed, the nanocapsules were observed to move from the water solution into the viscous nylon polymer in HFIP solution. This can be attributed to the high degree of hydrophobicity of nylon and polystyrene. Though the polystyrene nanocapsules were dispersed in water, they have a much greater affinity for nylon.

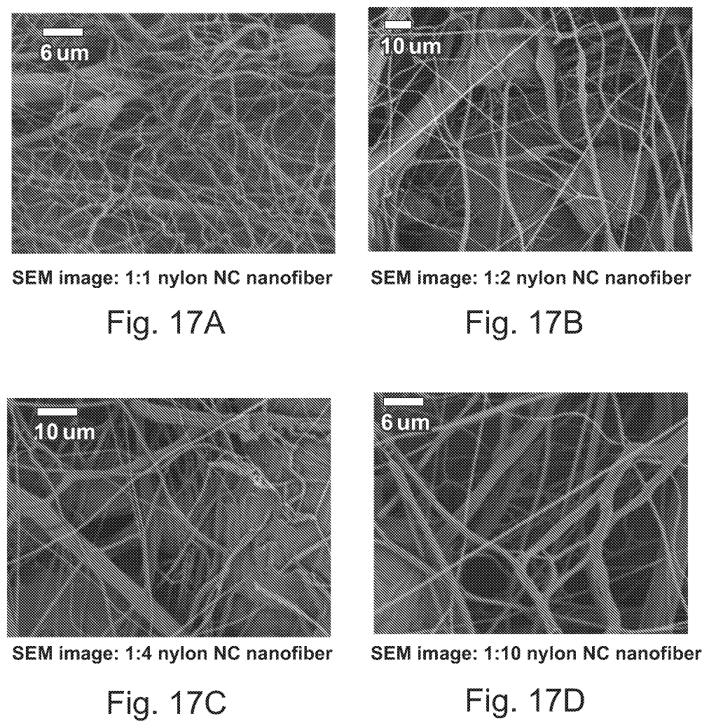

At the ratios investigated, the nanocapsules appeared to successfully spin into nanofibers and SEM images of the co-spun capsule-fibers were taken. FIG. 17A is a SEM image of nylon fibers spun from a solution with a 1:1 weight % ratio of nanocapsules to nylon. FIG. 17B is a SEM image of nylon fibers spun from a solution with a 1:2 weight % ratio of nanocapsules to nylon. FIG. 17C is an SEM image of nylon fibers spun from a solution with a 1:4 weight % ration of nanocapsules to nylon. FIG. 17D is an SEM image of nylon fibers spun from a solution with a 1:10 weight % ratio of nanocapsules to nylon. The nanocapsules can't be seen within the SEM images which is as expected because the nanocapsules diameter is approximately 200 nm, considerably smaller than the approximately 600 nm diameter of nanofibers.

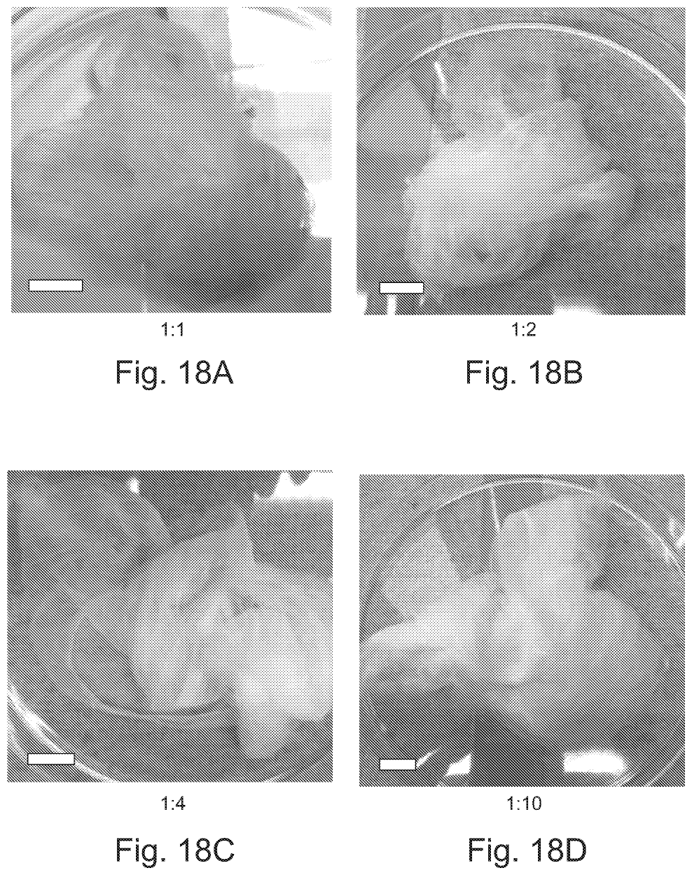

Images of nanofiber materials made from different ratios of lemongrass-PS/DVB nanocapsule solution to nanofiber solution are depicted in FIGS. 18A-18D, as marked with a 1 cm scale bar. FIG. 18B is an image of a nanofiber material made from a solution with a 1:2 wt % ratio of lemongrass nanocapsules to nylon. Although not shown in this greyscale image, the original color image shows the material having an off white/pale yellow color. FIG. 18B is an image of a nanofiber material made from a solution with a 1:2 wt % ratio of lemongrass nanocapsules to nylon. Although not shown in this greyscale image, the original color image shows the material having an off white/pale yellow color. FIG. 18C is an image of a nanofiber material made from a solution with a 1:4 wt % ratio of lemongrass nanocapsules to nylon. Although not shown in this greyscale image, the original color image shows the material having an ivory color. FIG. 18D is an image of a nanofiber material made from a solution with a 1:10 wt % ratio of lemongrass nanocapsules to nylon. The material is white.

The nanofiber materials underwent notable color changes immediately after fabrication that seem to suggest a rapid release of lemongrass oil that reaches equilibrium. The nanofiber material initially appeared white, then over about 30 minutes developed a pale to medium yellow color. This color remained fixed over time suggesting that the rate of lemongrass oil diffusion was minimal once a certain concentration of lemongrass was established in the nanofiber. This color development is visible over 30 minutes in a 1:9 nanocapsule nanofiber.

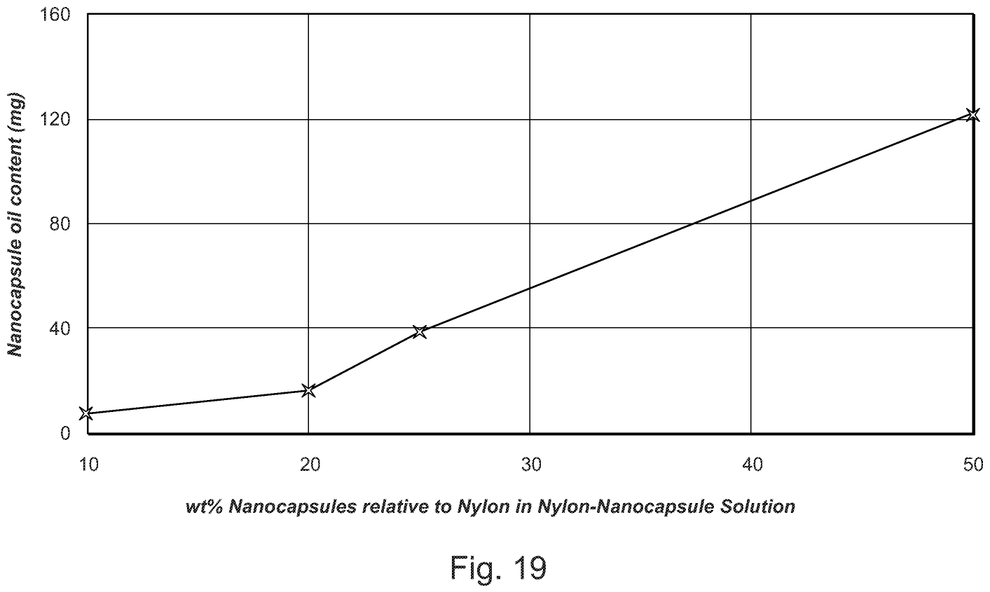

The load capacity of 500 mg samples of the various nanofiber materials was determined by extracting lemongrass oil into ethanol from a known weight of the nanofiber material and determining oil concentration using UV-Vis spectrophotometry as shown in the graph in FIG. 19.

The highest experimentally determined ratio of nanocapsule solution to nanofiber solution that produced fibers of acceptable quality using these materials and this fiber spinning process was a 1:1 ratio. At this ratio, 96% of the nanocapsules placed in solution were found within nanofibers. This set a practical limit for load capacity of the nanofibers using these particular material and techniques. Greater ratios of nanocapsule solution to nanofiber solution created very poor quality nanofibers or produced no nanofibers whatsoever. A hypothesis for this poor spinning phenomenon is that there was too much water in the polymer solution. Water is neither as volatile as HFIP, nor as solid as polymers. This means water is unlikely to evaporate when extruded through a rotating motor and will not solidify, leading to wet nanofibers or no nanofiber creation.

### Example 5: Wash Test

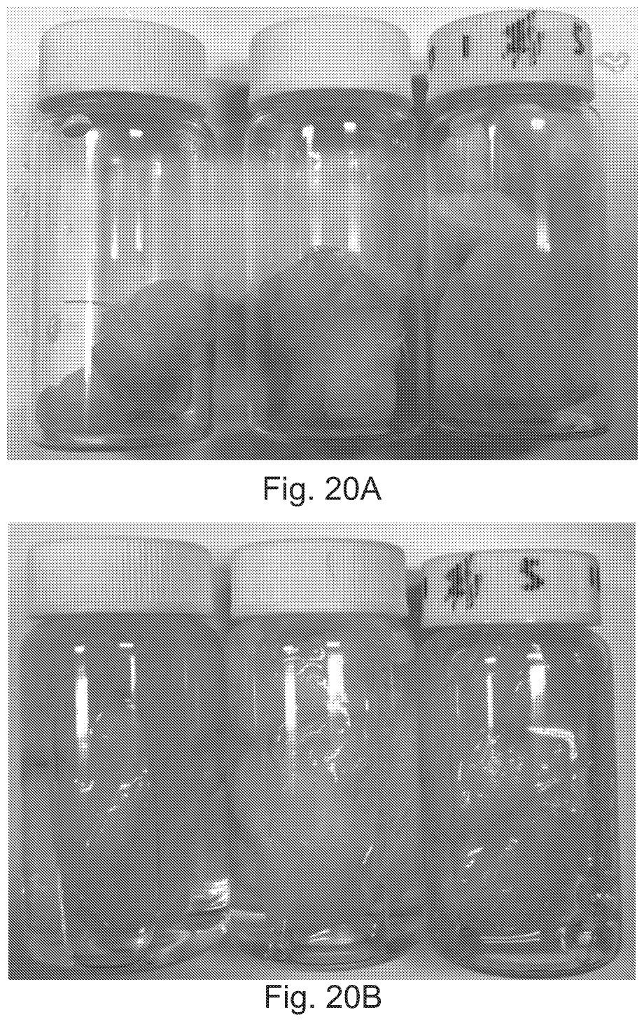

To test the wash durability of nanofiber materials in which nanocapsules are incorporated in the nanofibers, compared to simply dispersing nanocapsules on fabric or putting essential oil on fabric, 300 mg of fabric was washed with 4% soap solution for 30 min at 40° C. The ISO test employs a mechanical stirrer with approximately 40 rpm and 10 steel ball. In this experiment, the fabric swatches were instead washed at 350 rpm using a magnetic stirrer and stir bar. The samples were then rinsed with deionized water and air dried horizontally at room temperature. After drying, the remaining essential oil content was determined using the spectrophotometry method detailed previously. 1, 6, 16, 25, 30, 40, and 50 wash cycles were conducted. Three different fabrics types were tested: a) nanofibers incorporating nanocapsules—a non-woven polymeric fiber material with nanofibers each incorporating lemon oil nanocapsules, b) nanocapsule nanofibers—a non-woven polymeric fiber material with equivalent amount of nanocapsules dispersed on nanofibers' surface by sonicating nylon nanofibers in a water bath with a nanocapsule solution for 1 hour, and c) lemongrass nanofibers—a non-woven polymeric fiber material placed in an equivalent amount of lemongrass oil for 1 hour. This experiment was repeated three times. FIG. 20A is an image of three samples of nanofiber fabric pre-washing; specifically, the nanofiber material soaked in lemongrass oil (left) (hereafter referred to as the “soaked in lemongrass fabric”), a nanofiber material sonicated with lemongrass oil nanocapsules (center) (hereafter referred to as the “sonicated with nanocapsules fabric”), and a nanofiber material made of nanofibers that each incorporate one or more lemongrass oil nanocapsules (right) (hereafter referred to as the “incorporated nanocapsules fabric”). FIG. 20B is an image of the same three nanofiber fabric materials post-washing.

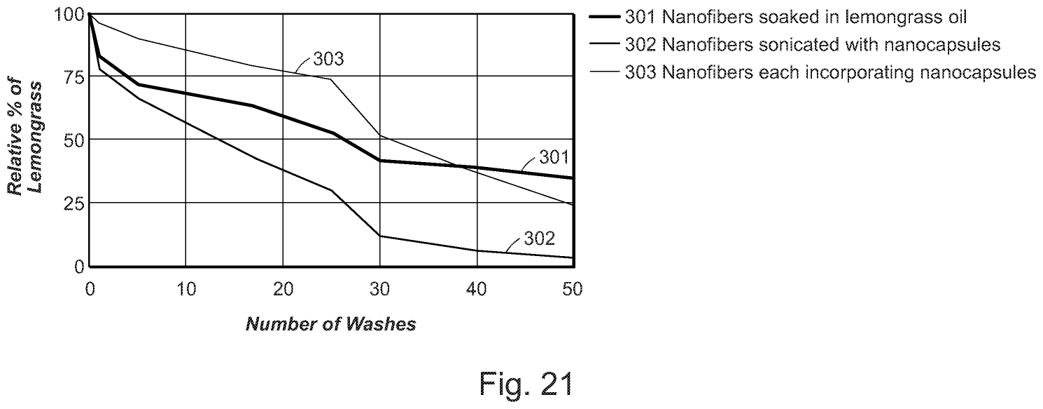

In FIG. 21, for each material, the ratio of the amount of essential oil remaining to amount of oil initially is graphed to determine the amount of washes until depletion. For all three types of materials, the lemongrass oil content decreased with increased washing. After a few washes, the soaked in lemongrass fabric 301 and the sonicated with nanocapsules fabric 302 lost approximately 20% of their essential oil content, while the incorporated nanocapsules fabric 303 lost just 10% of its essential oil content.

For the first thirty washes, the concentration of lemongrass essential oil in the soaked in lemongrass fabric 301 and the sonicated with nanocapsules fabric 302 decreased more rapidly than that of the incorporated nanocapsules fabric 303. In the sonicated with nanocapsules fabric 302, after 25 washes only 25% of the essential oil was retained compared to 75% for the incorporated nanocapsules fabric 303. After thirty washes, the soaked in lemongrass fabric 301 surprisingly had the greatest degree of lemongrass retention. It maintained 35% of its essential oil content and outperformed the incorporated nanocapsules fabric 303.

### Example 6: Antibacterial Test

The antimicrobial activity of the non-woven polymeric sheet material including nanofibers incorporating nanocapsules on cultures of B. subtilis and S. epidermis was investigated was investigated. The cultures were reseeded in 10 mL tryptic soy agar broth using a sterilized steriloop, then incubated for 18 hours. Using sterile technique, a sterile swab was placed into the broth culture then excess liquid was removed by pressing against the tube. The swab was then used to evenly and uniformly streak a tryptic soy agar plate. The plate was allowed to dry before testing samples were applied. 1:9,1:3 and 1:1 nanocapsule to nanofiber ratio fabric samples were cut into approximately 1 cm diameter pieces and then layered to create 8 mg test samples. 1 cm diameter pieces were also taken from control nylon nanofibers and layered into 10 mg test samples. These samples were placed on the aforementioned bacterial culture plates and incubated at 37° C. for 18 h. The experiment was repeated in triplicate.

These experiments aided in determining the required minimum percentage of contained essential oil to obtain microbial inhibition. B. subtilis and S. epidermis are particularly relevant to the generation of food malodor. Accordingly, the information obtained is particularly relevant for the development of materials for sock. For other applications, other bacteria may be alternatively, or additionally relevant. Assuming a sock is 610 cm² in surface area, total weight of nanocapsules within a sock is 5 g and the total weight of nanocapsule-nanofibers is 10 g (for a 1:1 ratio sock), 16 mg is the expected initial weight of nanofiber on a 1 cm² surface of the foot. Thus the 1:9, 1:3, and 1:1 samples represent 10%, 25%, and 100% of the original nanocapsule-nanofiber essential oil content respectively. By ascertaining the minimum percentage of contained essential oil at which inhibition of bacterial growth cannot be observed, this gives an estimate as to the minimum percentage of essential oil needed to retain antibacterial effect.

The Zone Inhibition test was used to assess growth reduction. In this method, if a bacterial strain is susceptible to the antibacterial agent, growth is inhibited and a zone of no bacterial growth is visible. The size of the zone may or may not be related to the level of antimicrobial activity or concentration of the agent so the results are typically interpreted as qualitative results.

The experiment was initially conducted in dry conditions. Very little to no inhibition of bacterial growth was observed. The experiment was then conducted again in the presence of 5 μL of phosphate buffer saline solution (PBS) to simulate sweat conditions when a sock is worn and slightly damp. After culturing with PBS solution, inhibition zones were observed confirming the antibacterial activity of lemongrass oil as detailed in the table below.

Inhibition Zones for 0, 10, 25 and 50% remaining lemongrass
in bacterial cultures of B. subtilis and S. epidermis

| | |
|---|---|
| 70% Weight | Inhibition Zone |

| Lemongrass | B. Subtilis | S. epidermis |
|---|---|---|
| 0 | 0 | 0 |
| 10 | 2 | 1 |
| 25 | 4 | 3 |
| 50 | 6 | 3 |

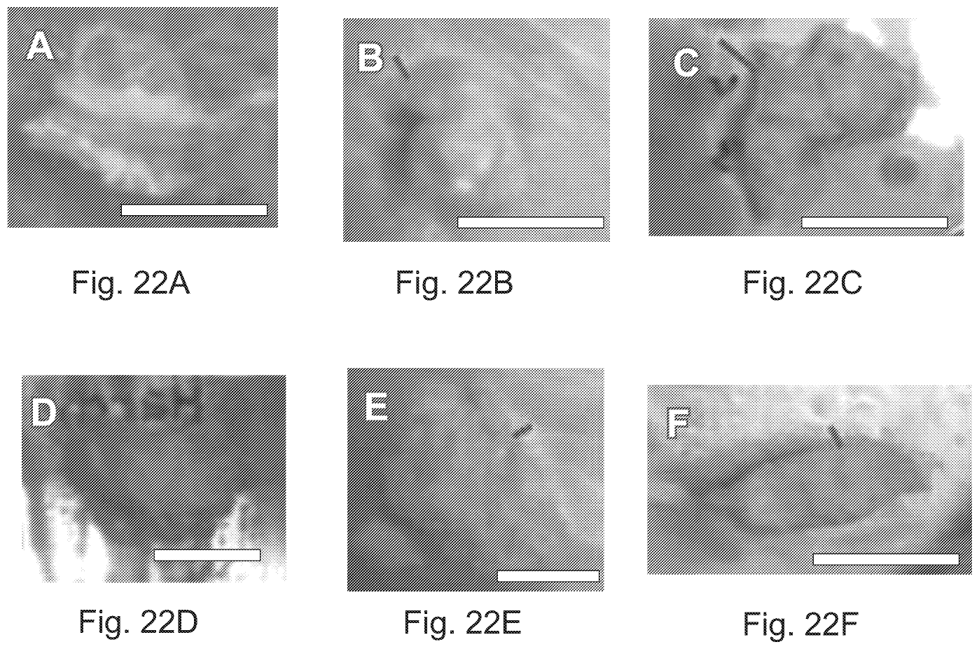

FIG. 22A is an image of a bacterial culture of Bacillus subtilis in nylon nanofibers. FIG. 22B is an image of a bacterial culture of Bacillus subtilis in nylon nanofibers with a 10% initial concentration of lemongrass. FIG. 22C is an image of a bacterial culture of Bacillus subtilis in nylon nanofibers with a 25% initial concentration of lemongrass. FIG. 22D is an image of a bacterial culture of Staphylococcus epidermis in nylon nanofibers. FIG. 22E is an image of a bacterial culture of Staphylococcus epidermis in nylon nanofibers with a 10% initial concentration of lemongrass. FIG. 22F is an image of a bacterial culture of Staphylococcus epidermis in nylon nanofibers with a 25% initial concentration of lemongrass. The material with the nylon control nanofibers had no inhibition zone as expected. The 10% sample had inhibition zones of 2 mm in B. subtilis and 1 mm in S. epidermis. The 25% sample had inhibition zones of 4 mm and 3 mm in B. subtilis and S. epidermis respectively.

### Example 7: Drug Release Models and Experimental Determination of Release

To quantitatively analyze drug release, mathematical formulas can be applied expressing as concentration or concentration gradient as a function of time. In this case, kinetic release models can describe and predict the concentration C of lemongrass oil remaining over time C(t.) Some commonly used functions include, 1) a diffusion model where flux is proportional to a concentration gradient, 2) zero order model—fixed rate of release, 3) first order—rate of release is proportional to concentration, 4) Higuchi model—moving boundary problem due to release from a matrix in a 2D planar system, and 5) Hixson-Crowell model for dissolving systems such as ingested tablets.

The polymer matrix should not dissolve through bulk degradation or boundary degradation as it is very inert and unreactive, plus divinylbenzene provides additional stability. The boundary of the polymer nanocapsule shell should remain fixed while the lemongrass slowly migrates through it. The lemongrass oil has much greater affinity to polystyrene compared with water. Its constituent compound citral has a polystyrene-water partition coefficient Kpolystyrene-water value of 3.7. This is extremely high: its predicts the existence of approximately 5000 molecules of citral within the nanocapsule core or polystyrene shell for every molecule in surrounding water. This dictates a fixed equilibrium between concentration in polystyrene nanocapsule Cp and surrounding water Cw given by the equation:

Cp/Cw=10^{3.7}=5011

Once this equilibrium is reached, no more lemongrass will be released by the nanocapsule until the water is cleared from the system by changing socks, washing socks or evaporation of lemongrass when feet are exposed.

A diffusion model given by Fick's First Law is J=−D∂c/∂x, where J is flux, D is diffusion coefficient, x is distance, and c is concentration. However Fick's Law is limited to homogenous systems and a core shell nanocapsule is not homogenous as each layer is made of a different material with different boundary conditions.

Despite this, the nanocapsules can be modeled under a zero-order release model as the fixed concentration gradient conditions should create a constant release rate. This is given by the equation: C=C₀−K₀t, where K₀ is the constant release rate.

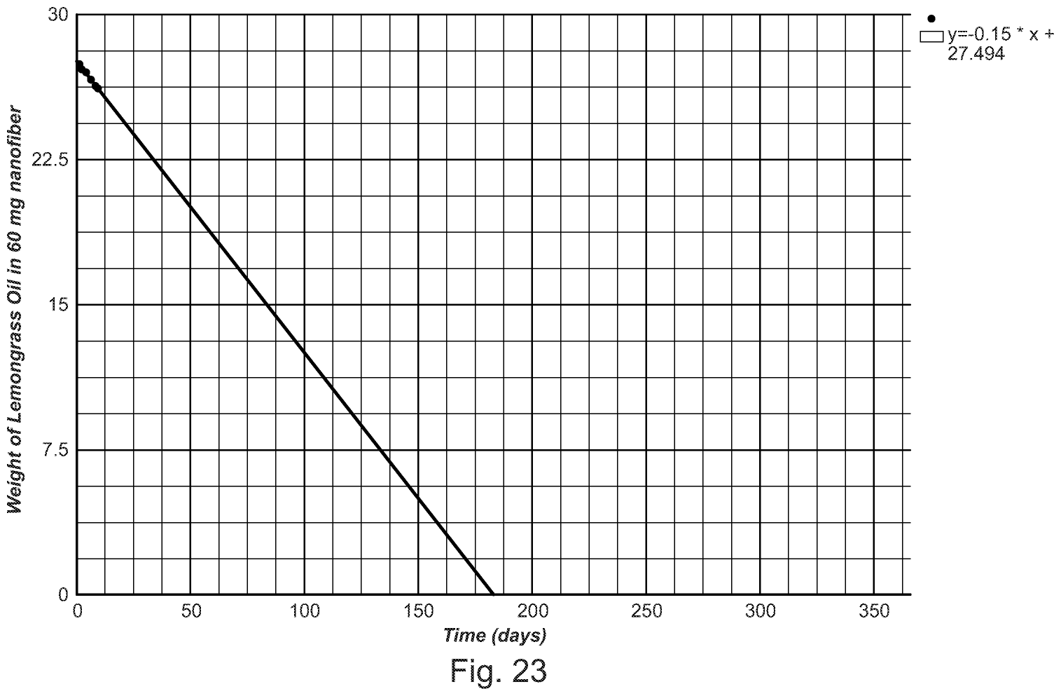

To estimate the release rate constant K₀, the nanofibers incorporating nanocapsules were left in a plastic petri dish exposed to the open air. After a period of 0.5, 1, 2, 3, 4, 5, 6 and 7 days, three 10 mg samples of nanofiber were retrieved from the bulk sample, sonicated in ethanol for 1 hour, and then centrifuged for 5 min at 5000 rpm, and the supernatant was collected. UV-Vis spectrophotometry was used to determine the concentration of essential oil left within the retrieved nanofiber. This decrease in concentration is plotted with circles in the graph in FIG. 23, which also shows a prediction (line) from a model based on this data assuming zero order drug release.

The concentration changed linearly suggesting that a zero order release model was a correct method for predicting nanofiber performance. The gradient of the graph was −0.15±0.02 thus the K₀ value is 2.5±0.3 with units of weight lemongrass released with respect to weight nanofiber per second. The projected lifetime of the product according to this method was 188±26 days.

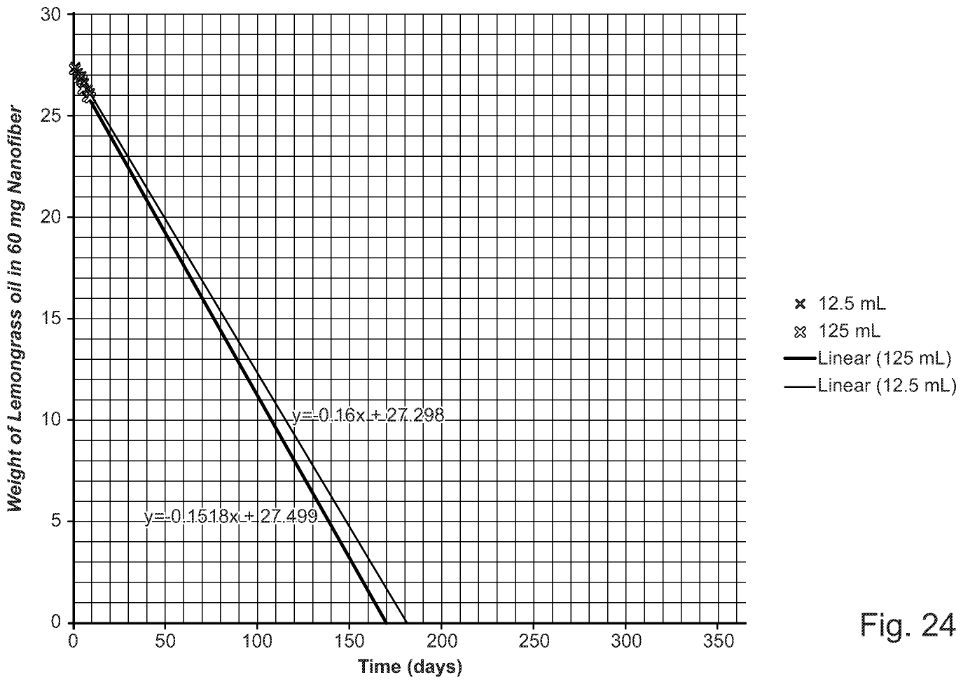

The test was then repeated to determine the release rate in low volumes of saline water in order to model low and high sweat conditions. Instead of exposing the nanocapsules to air, the nanocapsules were kept in a high volume PBS solution (125 mL per gram) and a low volume PBS solution (12.5 mL per gram) in a petri dish to prevent excess evaporation of water and water was re-added to the nanofiber every day over 1, 2, 3, 4, and 5 days. Three samples of 10 mg nanofiber were removed twice daily. The volumes of PBS solution were selected using experimental results from others for sweat rate in athletes as a high volume estimate, and were one order of magnitude lower, serving as a low volume estimate. This decrease in concentration is plotted with x's in the graph in FIG. 24, which also shows a predictions (lines) from a model based on this data assuming zero order drug release.

The lifetime of the low volume saline nanofiber was 182±13 days. Thus, there was no significant change compared to dry nanofiber. The lifetime of the high volume saline nanofiber was 160±17 days. This suggests that the nanofiber will express more lemongrass when exposed to high sweat volumes. This effect is both positive and negative: odor inhibition will increase but the product lifetime will decrease.

A host of factors such as temperature and humidity could also affect the rate constant and alter the effective lifetime of the nanofiber. Increased humidity would prevent evaporation of sweat and thus could lead to a greater release rate as the volume of water outside the nanofiber is greater. Temperature could also dramatically affect release rates—it is likely that an increase in temperature could lead to greater release of lemongrass. However the release will always be limited by the partition coefficient between polystyrene and water.

One of skill in the art would understand that in some embodiments, microparticles or nanoparticles could be employed in the materials, methods, and articles of clothing described above that are not microcapsules or nanocapsules. For example, in some embodiments, the at least one essential oil could be incorporated throughout the microparticle or nanoparticle as long as diffusion of the at least one essential oil from the microparticle or nanoparticle occurs at a rate that achieves the desired effect or functionality (e.g., microbial inhibition).

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements or method steps, those elements or steps may be replaced with a single element or step. Likewise, a single element or step may be replaced with a plurality of elements or steps that serve the same purpose. Further, where parameters for various properties are specified herein for exemplary embodiments, those parameters may be adjusted up or down by 1/20th, 1/10th, ⅕th, ⅓rd, ½, etc., or by rounded-off approximations thereof, unless otherwise specified. Moreover, while exemplary embodiments have been shown and described with references to particular embodiments thereof, those of ordinary skill in the art will understand that various substitutions and alterations in form and details may be made therein without departing from the scope of the invention. Further still, other aspects, functions and advantages are also within the scope of the invention.

The contents of all references, including patents and patent applications, cited throughout this application are hereby incorporated herein by reference in their entirety. The appropriate components and methods of those references may be selected for the invention and embodiments thereof. Still further, the components and methods identified in the Background section are integral to this disclosure and can be used in conjunction with or substituted for components and methods described elsewhere in the disclosure within the scope of the invention.

As may be recognized by those of ordinary skill in the pertinent art based on the teachings herein, numerous changes and modifications may be made to the above-described and other embodiments of the present disclosure without departing from the spirit of the invention as defined in the appended claims. Accordingly, this detailed description of embodiments is to be taken in an illustrative, as opposed to a limiting, sense. Those skilled in the art will recognize, or be able to ascertain using no more than routine experimentation, many equivalents to the specific embodiments of the described herein. Such equivalents are intended to be encompassed by the following claims.

1. A yarn comprising:
a plurality of nanocapsules, each nanocapsule comprising a polymeric shell surrounding at least one fluid comprising at least one essential oil, wherein the polymeric shell is configured to enable the at least one fluid to diffuse through the polymeric shell; and
a plurality of polymeric fibers co-spun with the plurality of nanocapsules.

2. (canceled)

3. (canceled)

4. The yarn of claim 1, wherein each of the nanocapsules is at least partially embedded in one or more of polymeric fibers.

5. (canceled)

6. The yarn of claim 1, wherein the essential oil comprises lemongrass.

7. The yarn of claim 1, wherein each polymeric shell comprises polystyrene.

8. (canceled)

9. The yarn of claim 1, wherein each of the nanocapsules has a diameter in a range of 10 nm to 1.1 μm; 10 nm to 3 μm; 10 nm to 300 nm; or 10 nm to 900 nm.

10.-15. (canceled)

16. A woven polymeric fiber sheet comprising the yarn of claim 1.

17. (canceled)

18. The polymeric fiber sheet of claim 16, further comprising:
at least a first layer of fabric adjacent to a first face of the polymeric fiber sheet; and
at least a second layer of fabric adjacent to a second face of the polymeric fiber sheet opposite the first face.

19. (canceled)

20. The yarn of claim 1 which inhibits the growth and/or activity of a microbe; or is two or more of deodorizing, antifungal, and antibacterial.

21. (canceled)

22. A method of manufacturing a material comprising:
providing a fiber-forming liquid including a polymer and a plurality of nanocapsules, each nanocapsule including a fluid encapsulated by a polymeric shell formed using miniemulsion polymerization; and
forming a plurality of polymeric fibers co-spun with the plurality of nanocapsules by ejecting or flinging the fiber-forming liquid from a reservoir.

23.-39. (canceled)

40. An article of clothing comprising the polymeric fiber sheet of claim 18.

41. (canceled)

42. An article of clothing comprising a sheet including:
plurality of nanocapsules, each nanocapsule comprising a polymeric shell surrounding at least one fluid comprising at least one essential oil, wherein the polymeric shell is configured to enable the at least one fluid to diffuse through the polymeric shell; and
a plurality of polymeric fibers co-spun with the plurality of nanocapsules.

43. The article of clothing of claim 42, wherein each of the nanocapsules has a diameter in a range of 10 nm to 1.1 μm; 10 nm to 3 μm; 10 nm to 300 nm; or 10 nm to 900 nm.

44.-48. (canceled)

49. The article of clothing of claim 42, wherein each of the nanocapsules is at least partially embedded in one or more of polymeric fibers.

50. (canceled)

51. (canceled)

52. The article of clothing of claim 42, wherein the article is configured to maintain at least 10% by weight essential oil relative to nanofiber content after 180 days; or is configured to maintain at least 10% by weight essential oil relative to nanofiber content after 50 washes.

53. (canceled)

54. The article of clothing of claim 42, wherein each polymeric shell comprises polystyrene.

55. (canceled)

56. The article of clothing of claim 42, wherein the article inhibits the growth and/or activity of a microbe.

57. The article of clothing of claim 42, further comprising:
at least a first layer of fabric adjacent to a first face of the sheet; and
at least a second layer of fabric adjacent to a second face of the sheet.

58. (canceled)
